(19) United States
(12) Patent Application Publication
(10) Pub. No.: US 2012/0169225 A1
(43) Pub. Date: Jul. 5, 2012

(54) ELECTRODE FOR DISCHARGE LAMP, METHOD OF MANUFACTURING ELECTRODE FOR DISCHARGE LAMP, AND DISCHARGE LAMP

(75) Inventors: Kazuhiro ITO, Tokyo (JP); Satoru WATANABE, Tokyo (JP); Naomichi MIYAKAWA, Tokyo (JP); Yutaka KUROIWA, Tokyo (JP); Setsuro ITO, Tokyo (JP)

(73) Assignee: Asahi Glass Company, Limited, Tokyo (JP)

(21) Appl. No.: 13/405,607

(22) Filed: Feb. 27, 2012

Related U.S. Application Data
(63) Continuation of application No. PCT/JP10/64533, filed on Aug. 26, 2010.

(30) Foreign Application Priority Data
Aug. 26, 2009 (JP) 2009-195394

(51) Int. Cl. H01J 61/04; H01B 1/08; H01B 1/02; H01J 9/02

(52) U.S. Cl. 313/631; 445/50; 252/518.1; 252/512

(57) ABSTRACT

An electrode for a discharge lamp is provided with a mayenite compound in at least a part of the electrode that emits secondary electrons, and the mayenite compound is fired in a vacuum atmosphere with an oxygen partial pressure of 10⁻³ Pa or less, an inert gas atmosphere with an oxygen partial pressure of 10⁻³ Pa or less, or a reducing atmosphere with an oxygen partial pressure of 10⁻³ Pa or less.

### CROSS-REFERENCE TO RELATED APPLICATIONS

This application is a continuation application filed under 35 U.S.C. 111(a) claiming the benefit under 35 U.S.C. 120 and 365(c) of a PCT International Application No. PCT/JP2010/064533 filed on Aug. 26, 2010, which is based upon and claims the benefit of priority of the prior Japanese Patent Application No. 2009-195394 filed on Aug. 26, 2009, the entire contents of which are incorporated herein by reference.

### BACKGROUND OF THE INVENTION

1. Field of the Invention

The present invention relates to discharge lamps, and to cold cathode fluorescent lamps in particular. More particularly, the present invention relates to an electrode for a discharge lamp, a method of manufacturing the electrode for the discharge lamp, and the discharge lamp, that includes a mayenite compound having a surface heat treated in a vacuum, an inert gas atmosphere, or a reducing atmosphere, in at least a part of the electrode or at a suitable location inside the cold cathode fluorescent lamp in order to reduce a cathode fall voltage and reduce power consumption, and to further improve a resistance to sputtering, so that a longer life may be achieved.

2. Description of the Related Art

A liquid crystal display (LCD) used in flat panel displays, personal computers, and the like has a built-in back light that uses a cold cathode fluorescent lamp as a light source to illuminate the LCD. FIG. 50 illustrates a structural diagram of a conventional cold cathode fluorescent lamp.

In FIG. 50, a glass tube 1 of a cold cathode fluorescent lamp 10 has an internal surface coated with a phosphor 3, and is sealed in a state in which a discharge gas such as argon (Ar), neon (Ne) and mercury (Hg) for exciting phosphor is introduced inside the glass tube 1. Electrodes 5A and 5B arranged in pairs symmetrically inside the glass tube 1 are cup-shaped cold cathodes, and one end of each of lead wires 7A and 7B is fixed to an end of corresponding electrodes 5A and 5B, while the other end of each of the lead wires 7A and 7B penetrates the glass tube 1.

Conventionally, the materials generally used for the cup-shaped cold cathode are nickel metal (Ni), molybdenum (Mo), tungsten (W), niobium (Nb), and the like. Amongst these materials, molybdenum is useful for an electrode that may reduce the cathode fall voltage but is expensive. Hence recently, a performance equivalent to that of molybdenum is obtained by coating an alkaline metal compound such as cesium (Cs) or an alkaline earth metal compound or the like on nickel which is inexpensive.

The cold cathode fluorescent lamp 10 emits light by glow discharge, and the glow discharge occurs due to the α effect of ionization of gas molecules caused by electrons moving between the cathode and the anode, and the γ effect of the so-called secondary electron emission of electrons that are emitted when positive ions of argon, neon, mercury, and the like collide with the negative electrode. In the glow discharge, the positive ion density of argon, neon, mercury becomes high in a cathode fall part which is a discharge part of the cathode side, and a “cathode fall voltage” phenomenon in which the voltage falls at the cathode fall part occurs.

The cathode fall voltage does not contribute to the light emission of the lamp, and as a result, this voltage causes an operating voltage to become high and the luminous efficacy to deteriorate.

In addition, there are demands to develop an electrode for cold cathode that may reduce the cathode fall voltage, with respect to recent market demands to increase the length of the cold cathode fluorescent lamps and to increase the luminance by driving with a large current.

The cathode fall voltage is related to the secondary electron emission described above, and depends upon the secondary electron emission coefficient of the cold cathode material that is selected. The secondary electron emission coefficient of the cold cathode metal material is 1.3 for nickel, 1.27 for molybdenum, and 1.33 for tungsten. Generally, the cathode fall voltage may be made lower by making the secondary electron emission coefficient larger, but because the secondary electron emission is greatly affected by the surface condition, a difference between the cathode fall voltages for nickel and molybdenum is difficult to judge.

As described above, molybdenum forms a cold cathode material that may form a cold cathode with reduced cathode fall voltage. Examples of materials that have secondary electron emission coefficients larger than that of molybdenum include metal iridium (Ir) and platinum (Pt). The secondary electron emission coefficient is 1.5 for iridium and 1.44 for platinum. In a Japanese Laid-Open Patent Publication No.2008-300043, an alloy of iridium and rhodium (Rh) is used in order to reduce the cathode fall voltage, however, the reduction is only on the order of 15% at most with respect to the cathode fall voltage for a case in which molybdenum is used.

In addition, the cold cathode fluorescent lamp has a problem in that ions of argon or the like generated during the glow discharge collide with the electrode, and causes wear of the cup electrode by sputtering. A sufficient amount of electrons may not be emitted as the cup electrode wears out, to thereby reduce the luminance. Accordingly, there is a problem in that the life of the electrode is shortened to shorten the life of the cold cathode fluorescent lamp.

In order to solve such problems, proposals have been made to coat the cup electrode surface with a material having resistance to sputtering, but there is a problem in that the performance of the secondary electron emission from the cup electrode deteriorates. For this reason, there are demands for a material having resistance to sputtering and enabling high performance of the secondary electron emission.

### SUMMARY OF THE INVENTION

The present invention is conceived in view of the above problems of the prior art, and one object is to provide an electrode for discharge lamp, a method of manufacturing the electrode for discharge lamp, and a discharge lamp, according to which a mayenite compound having a surface heat treated in a vacuum, an inert gas atmosphere, or a reducing atmosphere, may be included in at least a part of the electrode or at a suitable location inside a cold cathode fluorescent lamp in order to reduce a cathode fall voltage and reduce power consumption, and to further improve a resistance to sputtering, so that a longer life may be achieved.

An electrode for a discharge lamp according to the present invention may include a mayenite compound in at least a part of the electrode emitting secondary electrons, wherein the mayenite compound is fired in a vacuum atmosphere with an oxygen partial pressure of 10⁻³ Pa or less, an inert gas atmosphere with an oxygen partial pressure of 10⁻³ Pa or less, or a reducing atmosphere with an oxygen partial pressure of 10⁻³ Pa or less.

In the electrode for the discharge lamp of the present invention, the electrode may include a metal base, and the mayenite compound may be provided in at least a part of the metal base.

In addition, in the electrode for the discharge lamp of the present invention, at least a part of the electrode may be formed by a sintered body of the mayenite compound, at least a part of free oxygen ions of the mayenite compound may be substituted by electrons, and an electron density may be 1×10¹⁹ cm⁻³ or higher.

Moreover, in the electrode for the discharge lamp of the present invention, the firing may be performed in a reducing atmosphere.

Further, in the electrode for the discharge lamp of the present invention, the firing may be performed within a carbon container.

In addition, in the electrode for the discharge lamp of the present invention, the mayenite compound may include a 12CaO—7Al₂O₃ compound, a 12SrO—7Al₂O₃ compound, a mixed crystal compound of those, or an isomorphic compound of those.

Moreover, a method of manufacturing an electrode for a discharge lamp of the present invention may include forming a part of the electrode or the electrode in its entirety by a mayenite compound, and thereafter firing the mayenite compound in a vacuum atmosphere with an oxygen partial pressure of 10⁻³ Pa or less, an inert gas atmosphere with an oxygen partial pressure of 10⁻³ Pa or less, or a reducing atmosphere with an oxygen partial pressure of 10⁻³ Pa or less.

Further, a discharge lamp of the present invention may include the electrode for the discharge lamp as described above or, the electrode for the discharge lamp manufactured by the method of manufacturing the electrode for the discharge lamp as described above.

In addition, a discharge lamp of the present invention may include a glass tube, a discharge gas sealed inside the glass tube, and a mayenite compound provided inside the glass tube at a part making contact with the discharge gas, wherein the mayenite compound is fired in a vacuum atmosphere with an oxygen partial pressure of 10⁻³ Pa or less, an inert gas atmosphere with an oxygen partial pressure of 10⁻³ Pa or less, or a reducing atmosphere with an oxygen partial pressure of 10⁻³ Pa or less.

### BRIEF DESCRIPTION OF THE DRAWINGS

FIG. 1 is a structural diagram of an embodiment of the present invention;

FIG. 2 is a diagram for explaining an open cell discharge measuring apparatus;

FIGS. 3(a) and 3(b) illustrate an example of a case in which a mayenite compound is coated on an electrode;

FIGS. 4(a) and 4(b) illustrate an example of the case in which the mayenite compound is coated on the electrode;

FIGS. 5(a) and 5(b) illustrate an example of the case in which the mayenite compound is coated on the electrode;

FIGS. 6(a) and 6(b) illustrate an example of the case in which the mayenite compound is coated on the electrode;

FIGS. 7(a) and 7(b) illustrate an example of the case in which the mayenite compound is coated on the electrode;

FIGS. 8(a) and 8(b) illustrate an example of the case in which the mayenite compound is coated on the electrode;

FIGS. 9(a) and 9(b) illustrate an example of the case in which the mayenite compound is coated on the electrode;

FIGS. 10(a) and 10(b) illustrate an example of the case in which the mayenite compound is coated on the electrode;

FIGS. 11(a) and 11(b) illustrate an example of the case in which the mayenite compound is coated on the electrode;

FIGS. 12(a) and 12(b) illustrate an example of the case in which the mayenite compound is coated on the electrode;

FIGS. 13(a) and 13(b) illustrate an example of the case in which the mayenite compound is coated on the electrode;

FIGS. 14(a) and 14(b) illustrate an example of the case in which the mayenite compound is coated on the electrode;

FIGS. 15(a) and 15(b) illustrate an example of the case in which the mayenite compound is coated on the electrode;

FIGS. 16(a) and 16(b) illustrate an example of the case in which the mayenite compound is coated on the electrode;

FIGS. 17(a) and 17(b) illustrate an example of the case in which the mayenite compound is coated on the electrode;

FIG. 18 illustrates an example of the case in which the mayenite compound is coated on the electrode;

FIG. 19 illustrates an example of the case in which the mayenite compound is coated on the electrode;

FIG. 20 illustrates an example of the case in which the mayenite compound is coated on the electrode;

FIGS. 21(a)-21(c) illustrate an example of the case in which the mayenite compound is coated on the electrode;

FIGS. 22(a)-22(c) illustrate an example of the case in which the mayenite compound is coated on the electrode;

FIGS. 23(a)-23(c) illustrate an example of the case in which the mayenite compound is coated on the electrode;

FIGS. 24(a) and 24(b) illustrate an example of the case in which the mayenite compound is coated on the electrode;

FIGS. 25(a) and 25(b) illustrate an embodiment of an electrode formed by a sintered body of a mayenite compound;

FIGS. 26(a) and 26(b) illustrate an embodiment of the electrode formed by the sintered body of the mayenite compound;

FIGS. 27(a) and 27(b) illustrate an embodiment of the electrode formed by the sintered body of the mayenite compound;

FIGS. 28(a) and 28(b) illustrate an embodiment of the electrode formed by the sintered body of the mayenite compound;

FIGS. 29(a) and 29(b) illustrate an embodiment of the electrode formed by the sintered body of the mayenite compound;

FIGS. 30(a) and 30(b) illustrate an embodiment of the electrode formed by the sintered body of the mayenite compound;

FIGS. 31(a) and 31(b) illustrate an embodiment of the electrode formed by the sintered body of the mayenite compound;

FIGS. 32(a) and 32(b) illustrate an embodiment of the electrode formed by the sintered body of the mayenite compound;

FIGS. 33(a) and 33(b) illustrate an embodiment of the electrode formed by the sintered body of the mayenite compound;

FIGS. 34(a) and 34(b) illustrate an embodiment of the electrode formed by the sintered body of the mayenite compound;

FIGS. 35(a) and 35(b) illustrate an embodiment of the electrode formed by the sintered body of the mayenite compound;

FIG. 36 illustrates an embodiment of the electrode formed by the sintered body of the mayenite compound;

FIG. 37 illustrates an embodiment of the electrode formed by the sintered body of the mayenite compound;

FIGS. 38(a)-38(c) illustrate an embodiment of the electrode formed by the sintered body of the mayenite compound;

FIGS. 39(a)-39(c) illustrate an embodiment of the electrode formed by the sintered body of the mayenite compound;

FIGS. 40(a)-40(c) illustrate an embodiment of the electrode formed by the sintered body of the mayenite compound;

FIG. 41 is an electron micrograph illustrating a surface of the sintered body of the mayenite compound after surface treatment;

FIGS. 42(a)-42(c) are schematic diagrams illustrating a process of fainting a neck part of the sintered body of the conductive mayenite compound;

FIG. 43 is an electron micrograph illustrating a polished surface of the sintered body of the mayenite compound;

FIG. 44 is an electron micrograph illustrating the surface of the sintered body of the mayenite compound after surface treatment;

FIG. 45 is a diagram illustrating measured results of the cathode fall voltage for a sample A of the practical example;

FIG. 46 is a diagram illustrating measured results of the cathode fall voltage for a sample B of the practical example;

FIG. 47 is a diagram illustrating measured results of the cathode fall voltage for a sample C of the practical example;

FIG. 48 is a diagram illustrating measured results of the cathode fall voltage for a sample D of the practical example;

FIG. 49 is a diagram illustrating measured results of the cathode fall voltage for a sample E of the practical example;

FIG. 50 is a structural diagram of a conventional cold cathode fluorescent lamp;

FIG. 51 is a diagram illustrating measured results of the cathode fall voltage for a sample J of the practical example;

FIG. 52 is a diagram illustrating measured results of the cathode fall voltage for a sample K of the practical example;

FIG. 53 is a diagram illustrating measured results of the cathode fall voltage for a sample L of the practical example;

FIG. 54 is a diagram illustrating measured results of a discharge firing voltage and the cathode fall voltage for a sample M of the practical example when a product of a gas pressure P and an inter-electrode distance d is varied;

FIG. 55 is a diagram illustrating measured results of the cathode fall voltage for the sample M of the practical example; and

FIG. 56 is a diagram illustrating measured results of a tube current and a tube voltage for a sample N of the practical example after aging.

### DESCRIPTION OF THE PREFERRED EMBODIMENTS

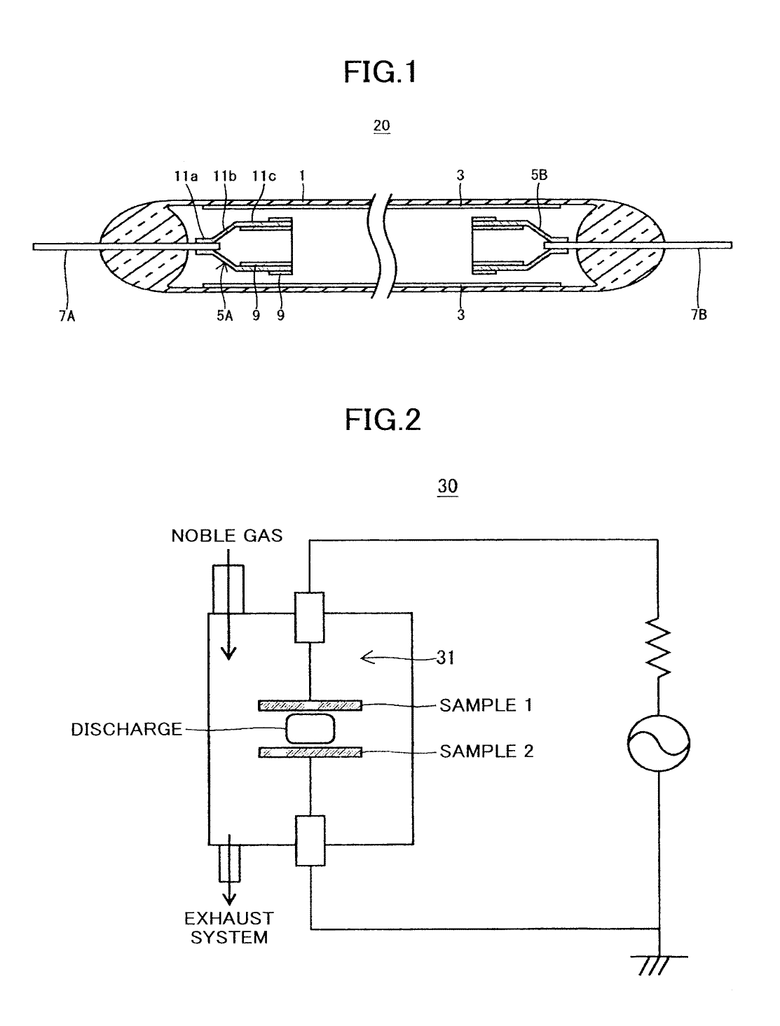

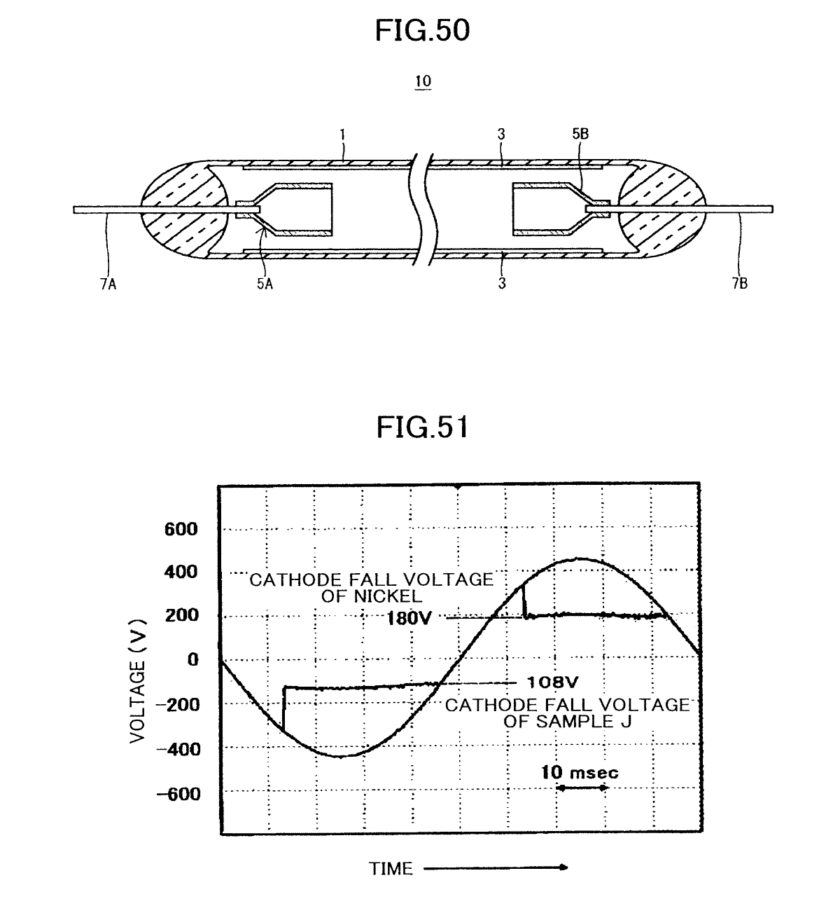

A description will hereinafter be given of embodiments of the present invention. FIG. 1 is a structural diagram of an embodiment of the present invention. FIG. 1 illustrates a cold cathode fluorescent lamp as an example of a discharge lamp to which the present invention may suitably be applied. In the cold cathode fluorescent lamp, an electrode for the discharge lamp corresponds to a cold cathode. In FIG. 1, those elements that are the same as those corresponding parts in FIG. 50 are designated by the same reference numerals, and a description thereof will be omitted.

In FIG. 1, electrodes 5A and 5B of a cold cathode fluorescent lamp 20 are held around respective lead wires 7A and 7B by holding parts 11a of the electrodes 5A and 5B. The electrodes 5A and 5B have a conical bottom part 11b that spreads in a conical shape from the holding part 11a, and a cylindrical part 11c that extends towards a discharge space from the conical bottom part 11b.

An inner side and an outer side of the electrodes 5A and 5B, which are cup-shaped cold cathodes, are coated with a mayenite compound 9 that is fired in a vacuum atmosphere with an oxygen partial pressure of 10⁻³ Pa or less, an inert gas atmosphere with an oxygen partial pressure of 10⁻³ Pa or less, or a reducing atmosphere with an oxygen partial pressure of 10⁻³ Pa or less. In this embodiment, the cup-shaped cold cathode is coated with the mayenite as an example. However, the shape of the electrode may be such that a tip end part of the cup has a hemispherical shape, and further, the electrode may have shapes other than the cup shape, including a strip shape, a tubular shape, a rod shape, a wire shape, a coil shape, and a hollow shape.

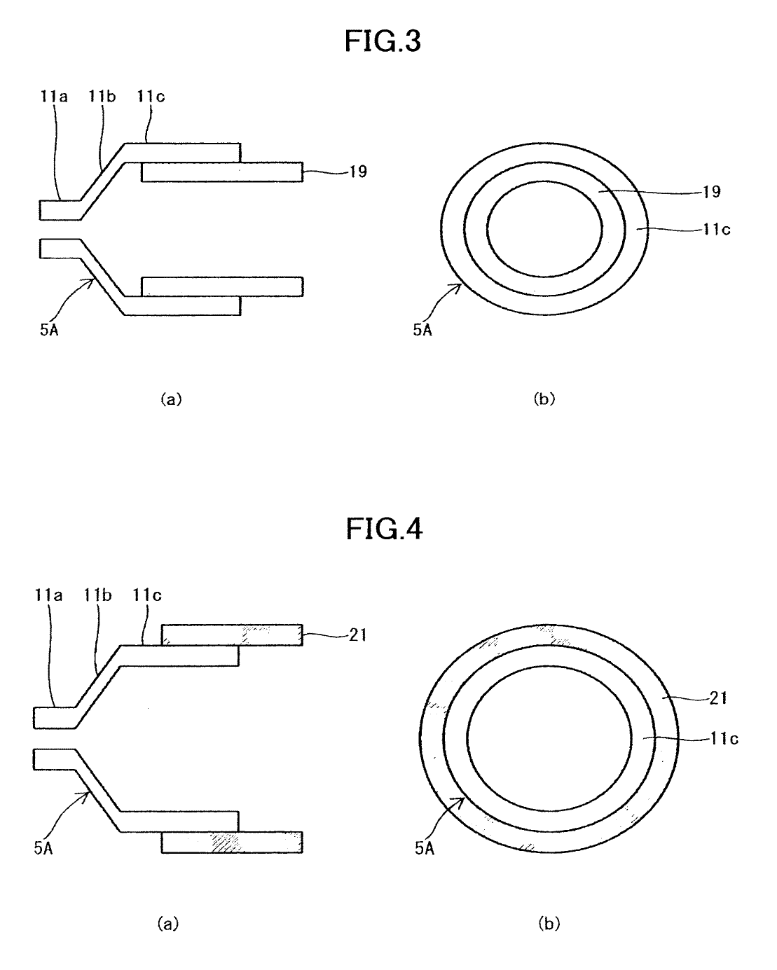

Examples of cases in which the mayenite is coated on the electrodes 5A and 5B are illustrated in FIG. 3(a)-FIG. 24(b). These are only examples, and these examples may be substantially combined. In FIG. 3(a)-FIG. 16(b), (a) illustrates a front cross sectional view of the electrode, and (b) illustrates a side view of the electrode.

First, a description will be given of cases in which the electrodes 5A and 5B have the cup shape.

FIG. 3(a) illustrates a front cross sectional view and FIG. 3(b) illustrates a side view of the cup-shaped electrode. In FIG. 3, a mayenite compound 19 is coated in a cylindrical manner on an inner peripheral surface of the cylindrical part 11c. The mayenite compound 19 may project from the cup as illustrated in FIG. 3(a).

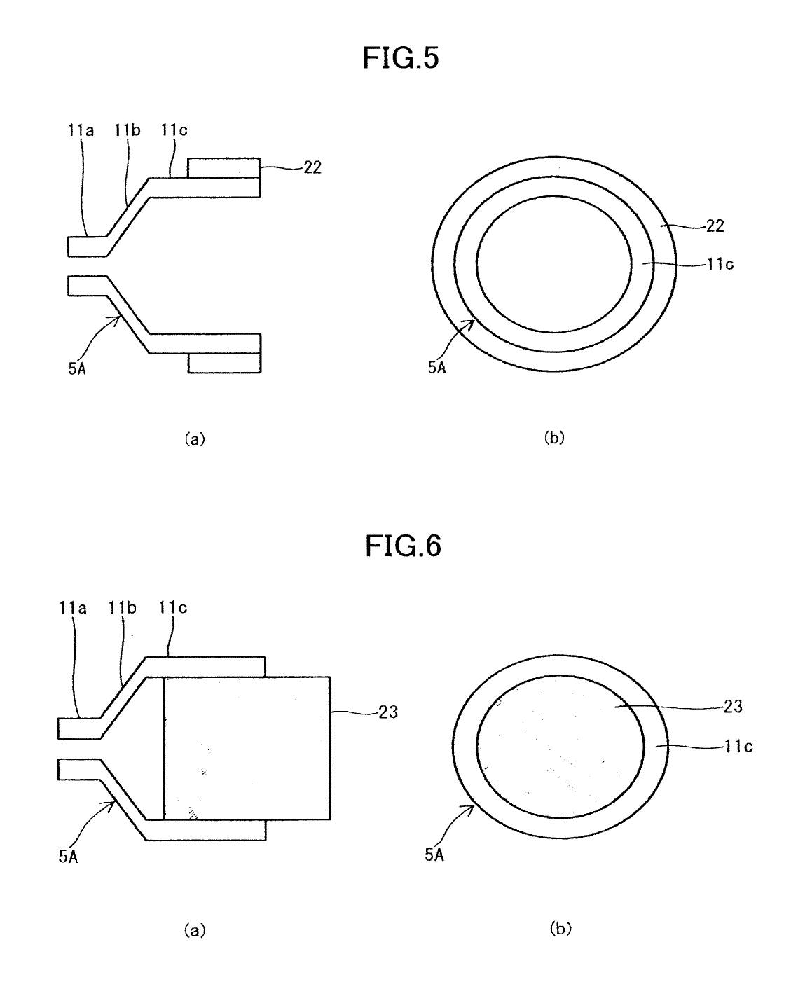

A mayenite compound 21 may be coated in a cylindrical manner on an outer peripheral surface of the cylindrical part 11c, as illustrated in FIGS. 4(a) and 4(b). In this case, the mayenite compound 21 may project from the cup as illustrated in FIG. 4(a) or, the mayenite compound 22 may aligned to the end of the cup so as not to project from the cup as illustrated in FIG. 5(a).

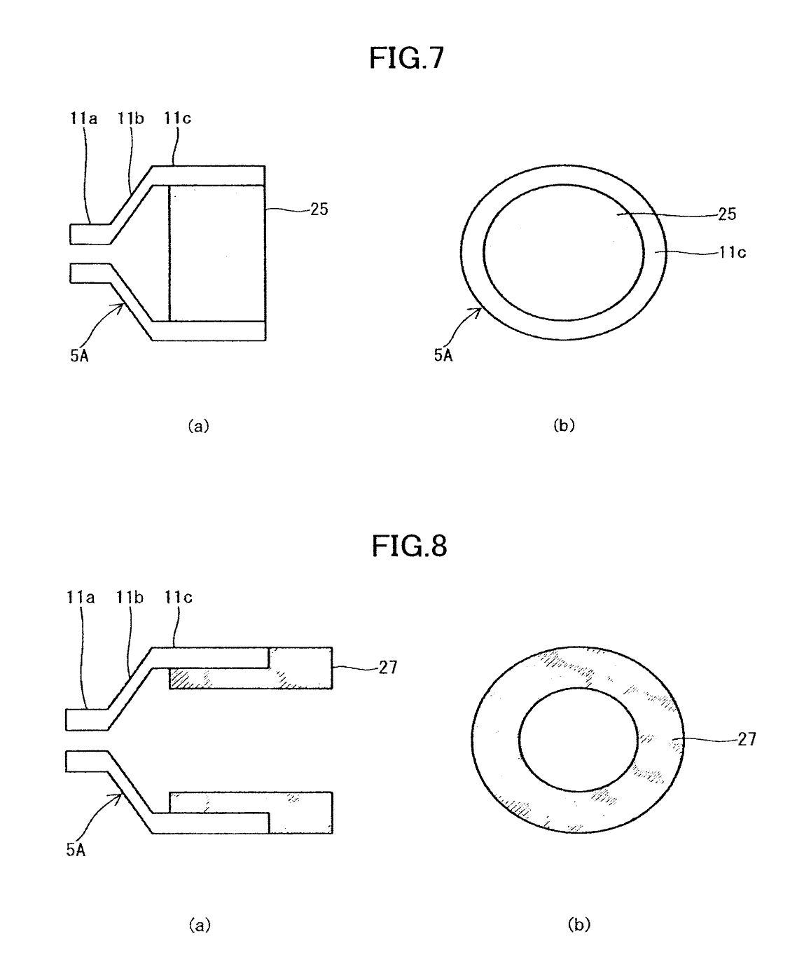

Further, a cylindrical column-shaped mayenite compound 23 may be inserted into the cylindrical part 11c so as to partially project from the cylindrical part 11c as illustrated in FIGS. 6(a) and 6(b) or, a cylindrical column-shaped mayenite compound 25 may be accommodated within the cylindrical part 11c as illustrated in FIGS. 7(a) and 7(b).

Moreover, a projecting portion of a mayenite compound 27 may have a cylindrical shape with a diameter that is larger than that of a cylindrical portion inserted into the cylindrical part 11c, as illustrated in FIGS. 8(a) and 8(b).

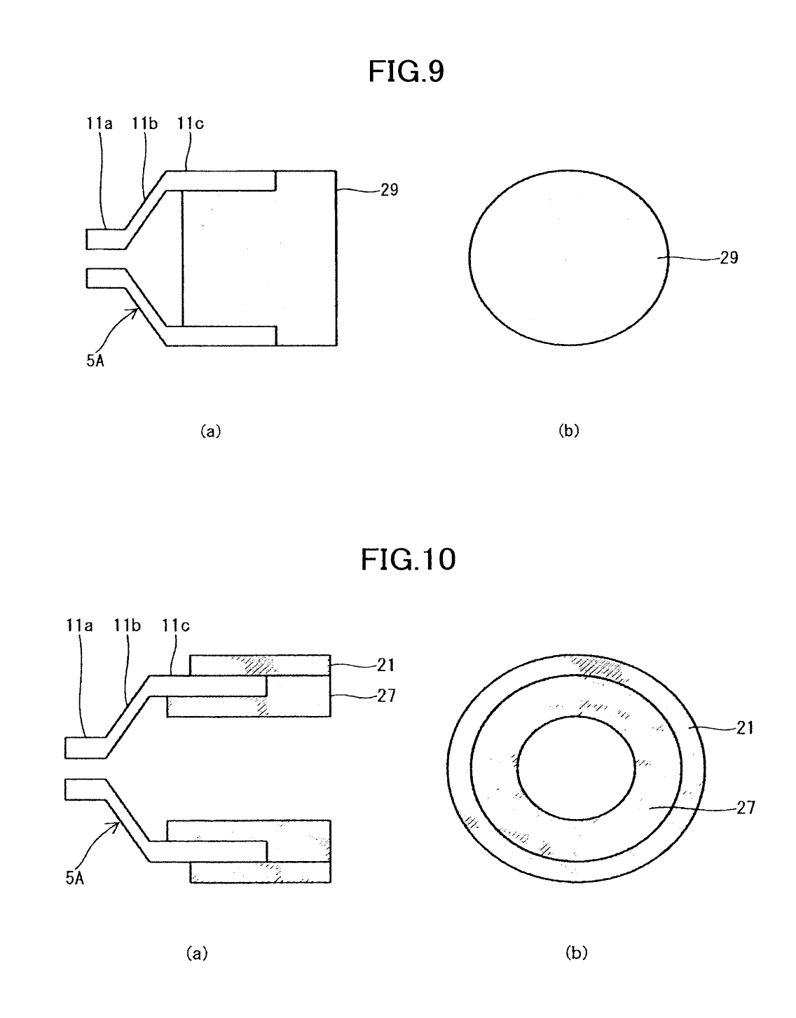

In addition, a projecting portion of a mayenite compound 29 may have a cylindrical column shape with a diameter that is larger than that of a cylindrical column portion that is inserted into the cylindrical part 11c, as illustrated in FIGS. 9(a) and 9(b).

Further, the mayenite compound 27 and the mayenite compound 21 may be combined, as illustrated in FIGS. 10(a) and 10(b).

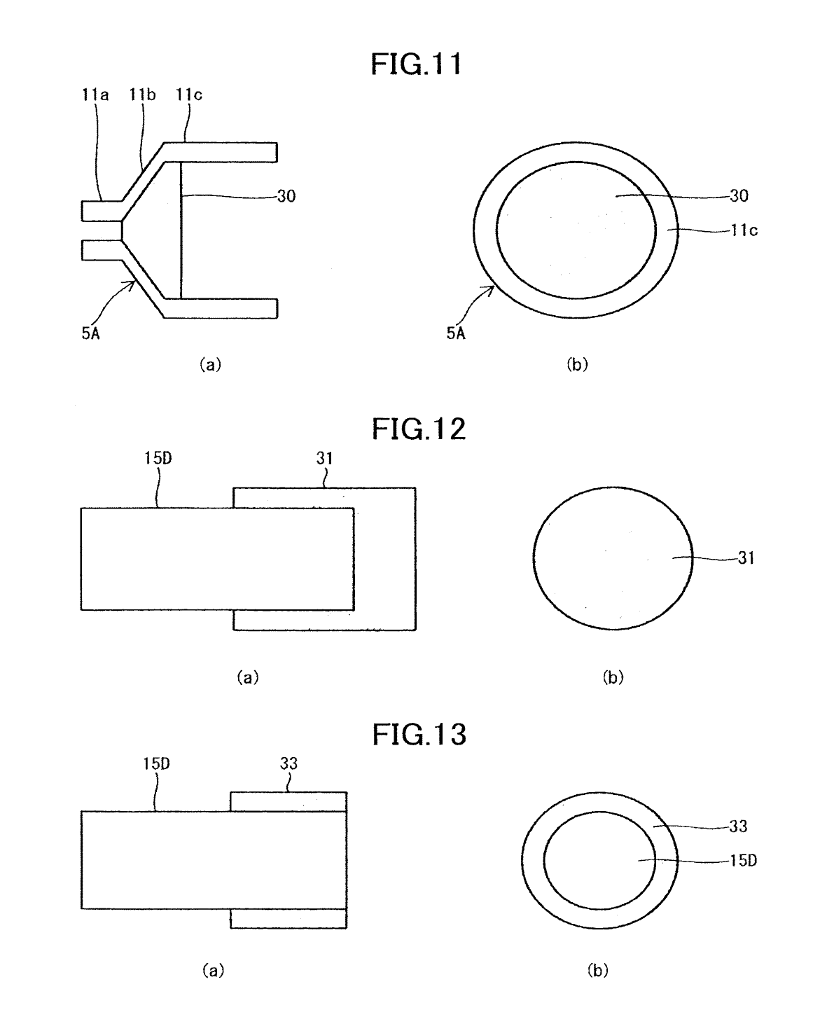

Moreover, a mayenite compound 30 may be accommodated in an inner side of the conical bottom part 11b, as illustrated in FIGS. 11(a) and 11(b).

Next, a description will be given of cases in which the electrode has a rod shape or a cylindrical column shape.

FIGS. 12(a) and 12(b) illustrate an example in which a tip end part of a rod shaped or cylindrical column-shaped electrode 15D is coated with a mayenite compound 31 to a cylindrical shape with a covered bottom so that an outer periphery and a head portion of the electrode 15D will not be exposed.

In addition, FIGS. 13(a) and 13(b) illustrate an example in which a mayenite compound 33 is coated only on a tip end outer periphery of the electrode 15D.

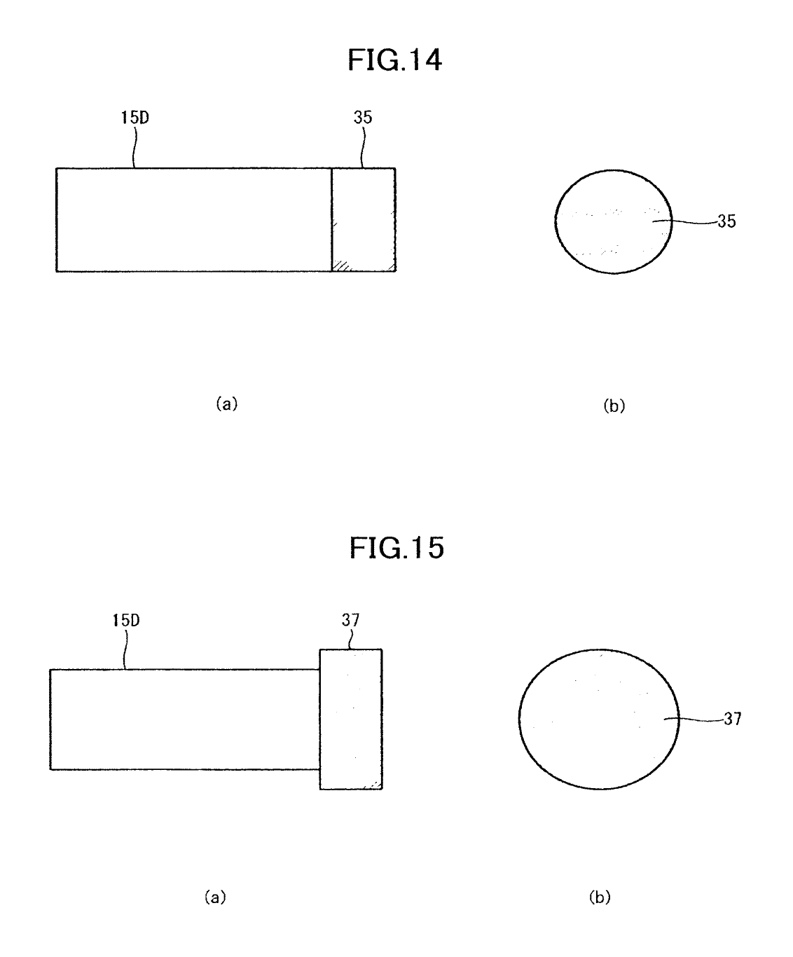

Further, FIGS. 14(a) and 14(b) illustrate an example in which a mayenite compound 35 is coated only on the tip end head portion of the electrode 15D by matching the diameter of the mayenite compound 35 to that of the electrode 15D.

Moreover, FIGS. 15(a) and 15(b) illustrate an example in which a mayenite compound 37 is coated only on the tip end head portion of the electrode 15D to protrude from the tip end head portion by exceeding the diameter of the electrode 15D.

Next, a description will be given of cases in which the electrode has a wire shape.

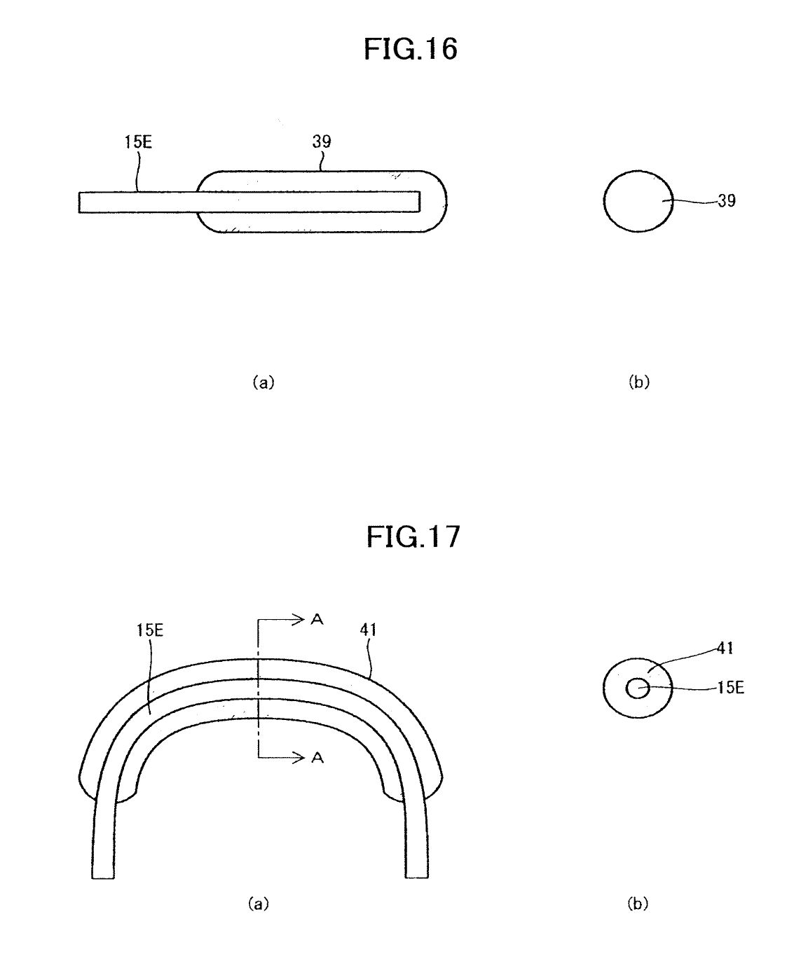

FIGS. 16(a) and 16(b) illustrate an example in which a mayenite compound 39 coats a tip end part of a wire-shaped electrode 15E so that an outer periphery and a head portion of the electrode 15E will not be exposed.

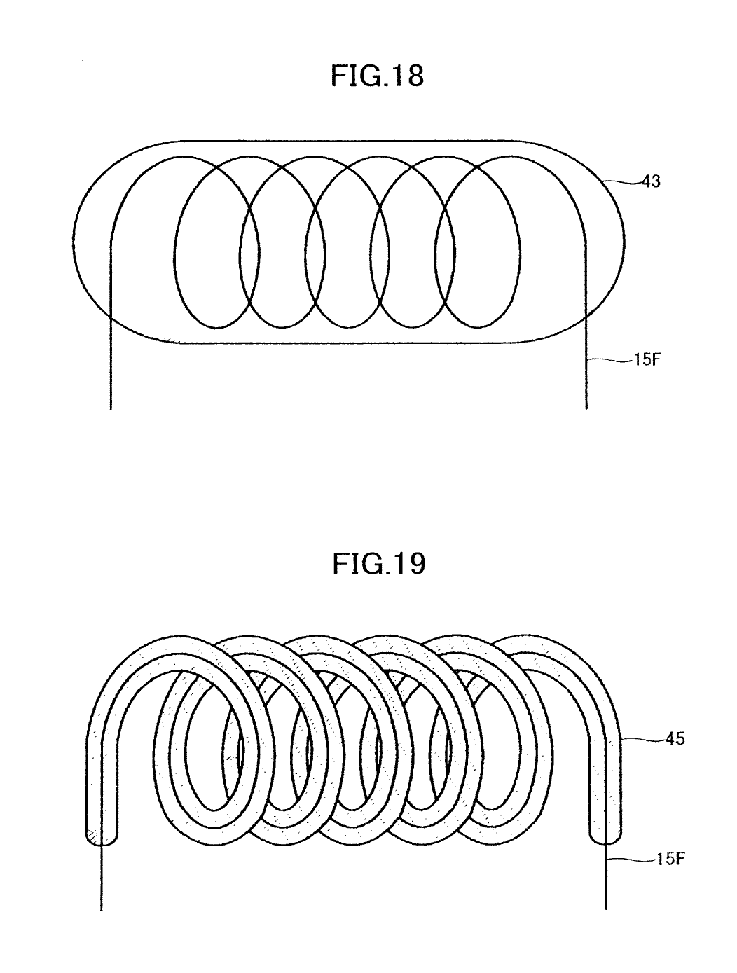

In addition, FIGS. 17(a) and 17(b) illustrate an example in which the wire-shaped electrode 15E is bent in a U-shape that opens towards a discharge space. FIG. 17(b) is a cross sectional view taken along an arrow line A-A in FIG. 17(a). In this example, a mayenite compound 41 coats the U-shaped tip end part of the wire-shaped electrode 15E so that an outer periphery of the tip end part will not be exposed.

Next, a description will be given of a case in which the electrode is a filament formed to a coil shape.

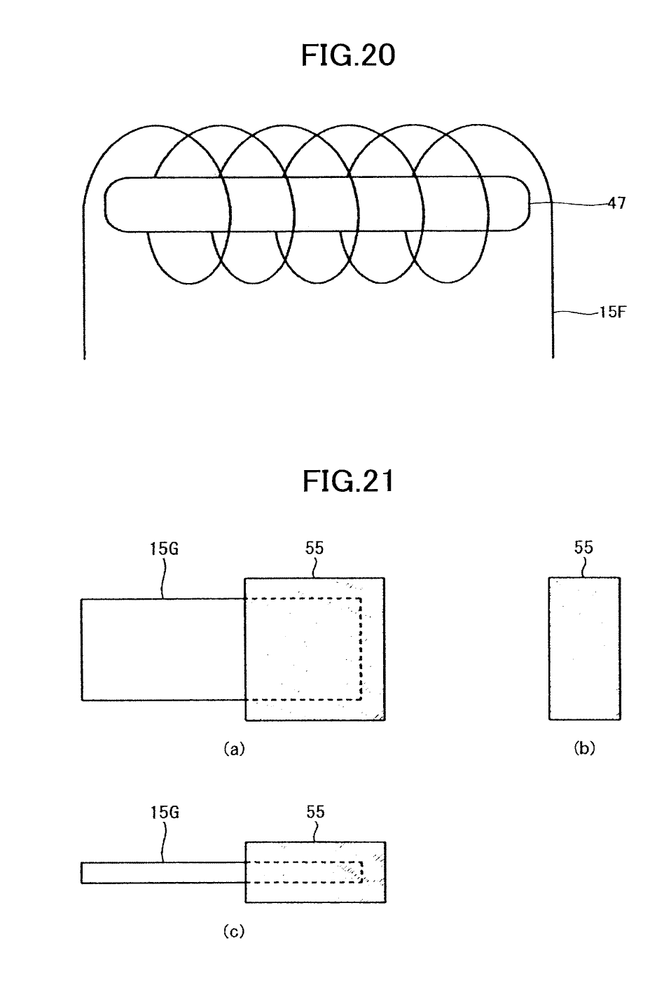

As illustrated in FIG. 18, a mayenite compound 43 may be disposed to cover the entire coil part of a filament 15F. As illustrated in FIG. 19, a mayenite compound 45 may be disposed to cover the wire of the filament 15F. Further, a mayenite compound 47 may be carried inside the coil, as illustrated in FIG. 20.

Next, a description will be given of a case in which the electrode has a strip shape.

FIG. 21(a) illustrates a plan view, FIG. 21(b) illustrates a side view, and FIG. 21(c) illustrates a bottom view. As illustrated in FIG. 21, a mayenite compound 55 may cover a tip end part of a strip-shaped electrode 15G so that a top end periphery and a tip end head part will not be exposed.

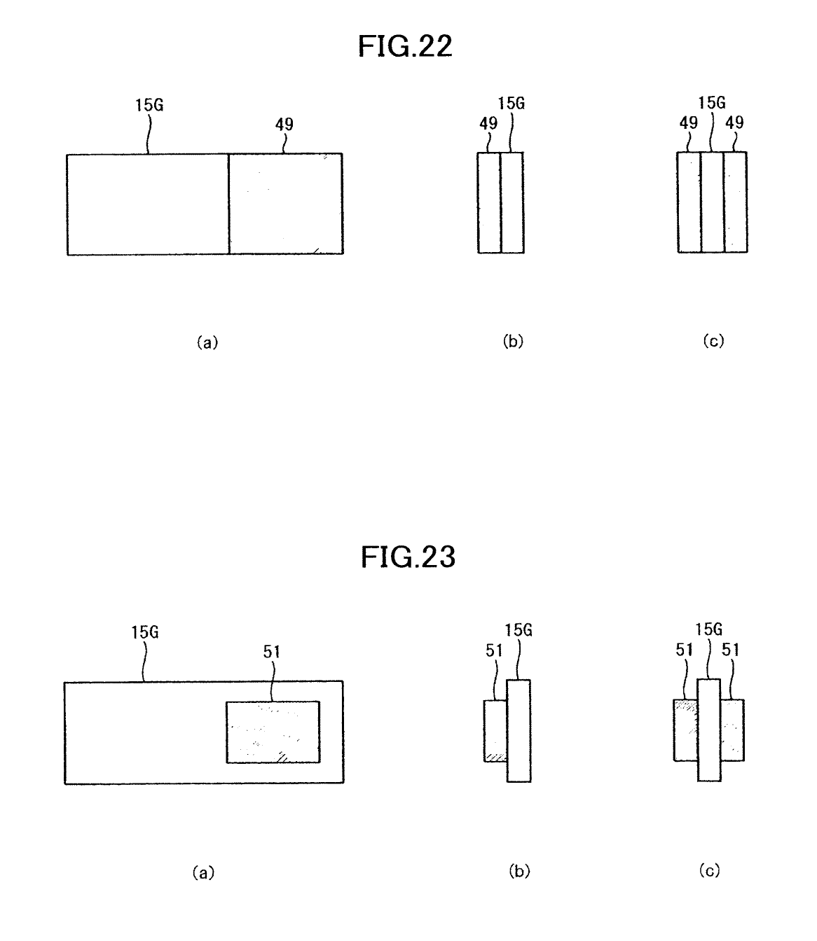

FIG. 22(a) illustrates a plan view, and FIGS. 22(b) and 22(c) illustrate side views. FIG. 22 illustrates an example in which a mayenite compound 49 is coated on a tip end part of the strip-shaped electrode 15G. The mayenite compound may be coated only on one surface of the electrode as illustrated in FIG. 22(b), and the mayenite compound may be coated on both surfaces of the electrode as illustrated in FIG. 22(c).

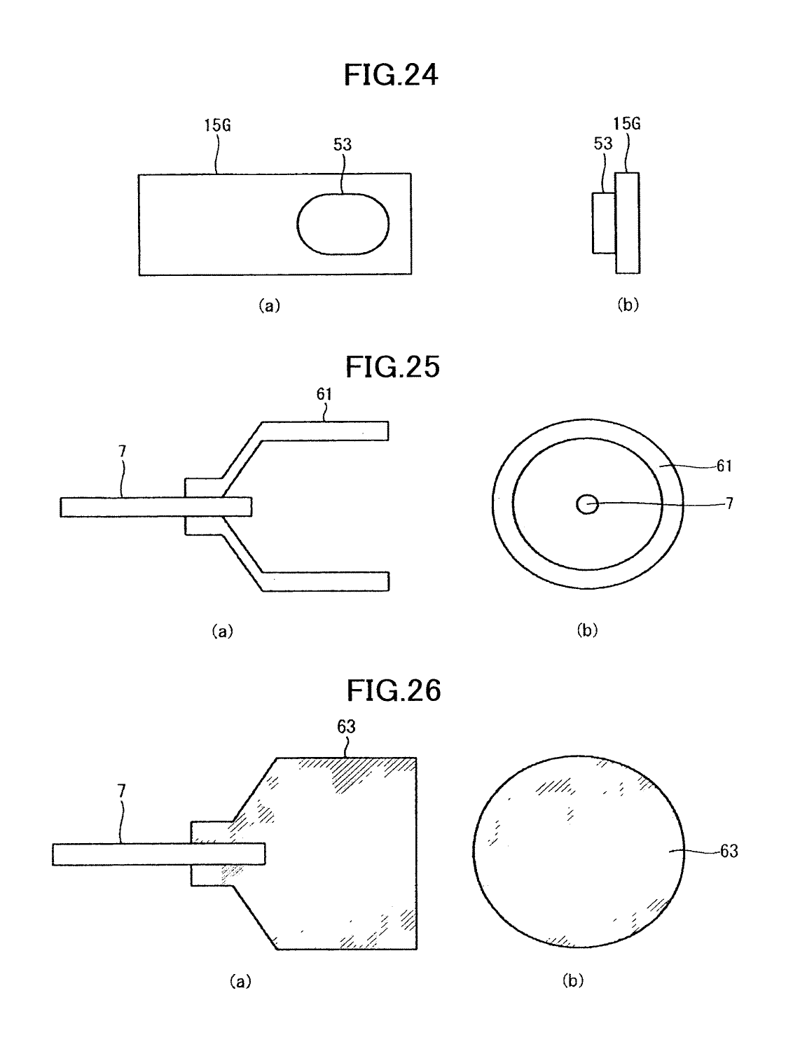

The coverage shape of mayenite compound may be freely selected. As illustrated in FIGS. 23(a)-23(c), a mayenite compound 51 may be partially coated in a rectangular shape with respect to an electrode surface. In addition, as illustrated in FIGS. 24(a) and 24(b), a mayenite compound 53 may be coated in an oval shape. FIGS. 23(a) and 24(a) illustrate plan views, and FIGS. 23(b), 23(c) and 24(b) illustrate side views.

In each of the structures described above, the mayenite compound may be sprayed in powder fault, coated to a thick film, or filled into the cup or cylinder. The mayenite compound is preferably coated to a thickness of 5 μm to 300 μm. In the case in which the mayenite compound projects, the projecting portion preferably has a length of 30 mm or less.

In this embodiment, the mayenite compound 9 that has been fired in a vacuum atmosphere with an oxygen partial pressure of 10⁻³ Pa or less, an inert gas atmosphere with an oxygen partial pressure of 10⁻³ Pa or less, or a reducing atmosphere with an oxygen partial pressure of 10⁻³ Pa or less coats the entire periphery on the inner side and partially coats the outer side of the cup-shaped cold cathode. In other words, in the cold cathode fluorescent lamp 20 of this embodiment, the mayenite compound is provided on at least a part of the electrodes 5A and 5B.

However, the mayenite compound that has been fired in the vacuum atmosphere with the oxygen partial pressure of 10⁻³ Pa or less, the inert gas atmosphere with the oxygen partial pressure of 10⁻³ Pa or less, or the reducing atmosphere with the oxygen partial pressure of 10⁻³ Pa or less may exist inside the cold cathode fluorescent lamp 20, not only in the electrode, and a reduction in the cathode fall voltage may be expected as long as the mayenite compound is in contact with a discharge gas. For this reason, the mayenite compound may exist at locations in contact with the discharge gas, including the inside of the glass tube 1, the electrode existing inside the glass tube 1, the phosphor 3, and other parts (for example, a metal or the like arranged in a vicinity of the electrode).

Therefore, in the present invention, the mayenite compound is provided in at least a part of the discharge lamp electrode, and the mayenite compound is fired in the vacuum atmosphere with the oxygen partial pressure of 10⁻³ Pa or less, the inert gas atmosphere with the oxygen partial pressure of 10⁻³ Pa or less, or the reducing atmosphere with the oxygen partial pressure of 10⁻³ Pa or less, in order to realize the electrode for the discharge lamp that may reduce the cathode fall voltage.

Accordingly, as described above, the electrode for the discharge lamp in the present invention may be the cold cathode having the mayenite compound, fired in the vacuum atmosphere with the oxygen partial pressure of 10⁻³ Pa or less, the inert gas atmosphere with the oxygen partial pressure of 10⁻³ Pa or less, or the reducing atmosphere with the oxygen partial pressure of 10⁻³ Pa or less, in at least a part of the electrode including a metal base such as nickel, molybdenum, tungsten, and niobium.

Examples of the shape of the electrode including the metal base may include the cup shape, strip shape, tubular shape, rod shape, wire shape, coil shape, hollow shape, and the like. Examples of the metal base include nickel, molybdenum, tungsten, niobium, and alloys of such metals, including kovar, but the metal base is not limited to such metals. Particularly, nickel and kovar are preferable because such materials are easily available and are inexpensive.

FIG. 1 and FIG. 3(a)-FIG. 24(b) illustrate examples of the embodiments in which the mayenite compound covers the cold cathode. However, the present invention is not limited to the embodiment in which the mayenite compound covers the electrode including the metal base. In other words, the electrode may be formed solely by the mayenite compound, and a bulk of a sintered body of the mayenite compound, or the like, may form the electrode for the discharge lamp. In this case, the bulk formed to the desired shape of the electrode for the discharge lamp needs to be fired in the vacuum atmosphere with the oxygen partial pressure of 10⁻³ Pa or less, the inert gas atmosphere with the oxygen partial pressure of 10⁻³ Pa or less, or the reducing atmosphere with the oxygen partial pressure of 10⁻³ Pa or less.

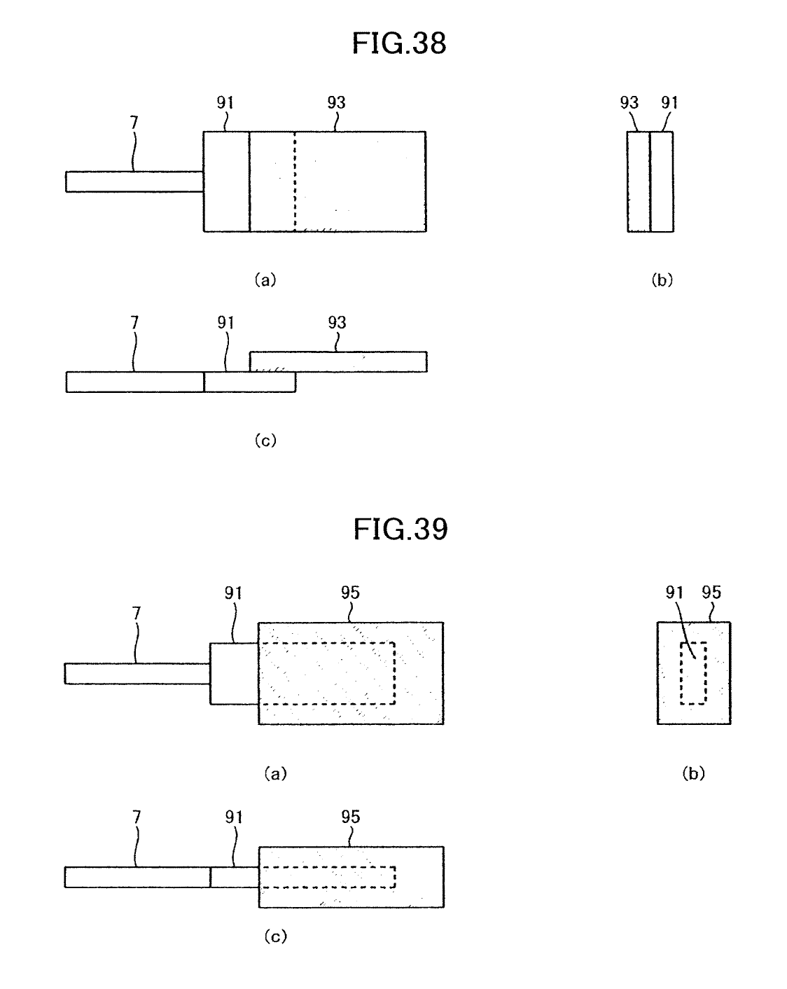

Examples of the electrodes foamed solely by the sintered body of the mayenite compound are illustrated in FIG. 25(a)-FIG. 40(c). In FIG. 25(a)-FIG. 35(b), (a) illustrates a front cross sectional view, and (b) illustrates a side view. In addition, FIGS. 36 and 37 illustrate plan views. In FIG. 38(a)-FIG. 40(c), (a) illustrates a front cross sectional view, (b) illustrates a side view, and (c) illustrates a bottom view.

FIGS. 25(a) and 25(b) illustrate an example in which the cup-shaped electrode is formed by a sintered body 61 of the mayenite compound. However, as illustrated in FIGS. 26(a) and 26(b), the inside of the cup may be filled by a sintered body 63 of the mayenite compound.

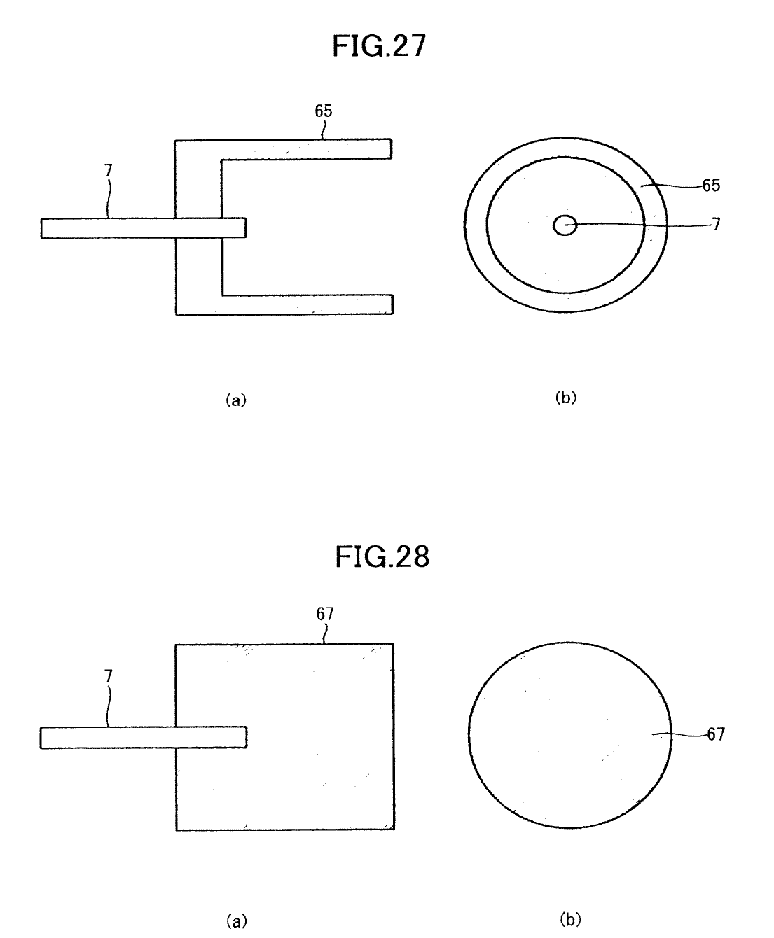

FIGS. 27(a) and 27(b) illustrate an example in which the electrode is formed to a tubular shape from a sintered body 65 of the mayenite compound. FIGS. 28(a) and 28(b) illustrate an example in which the electrode is formed to a cylindrical column shape from a sintered body 67 of the mayenite compound.

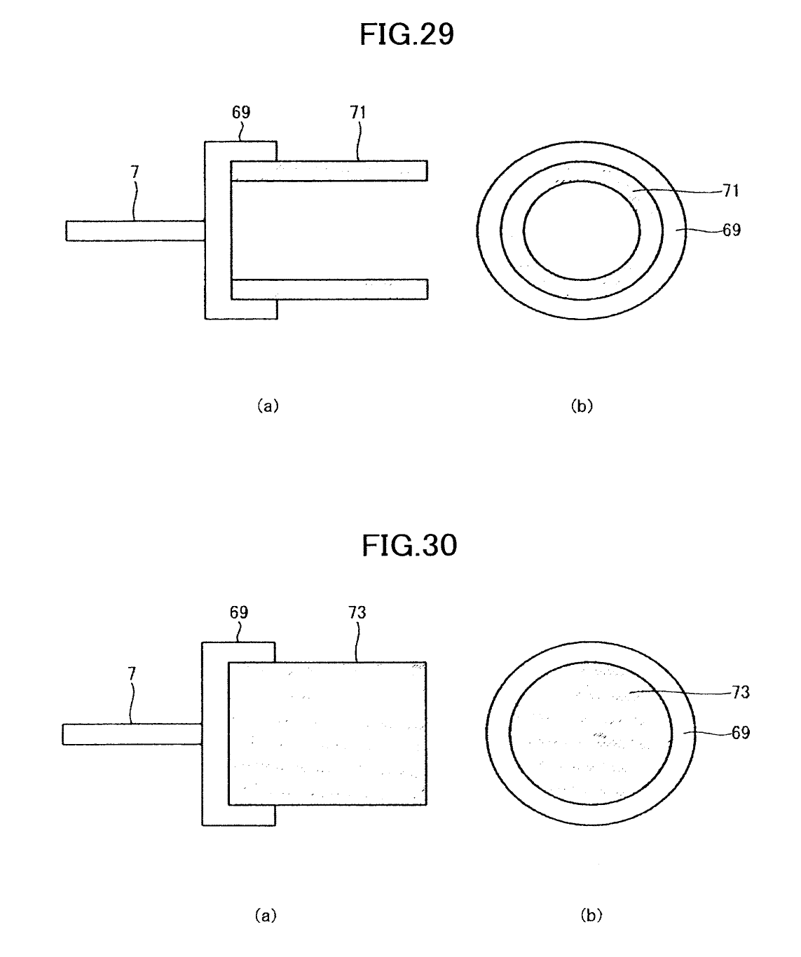

FIG. 29(a)-FIG. 34(b) illustrate examples in which the electrode formed by the sintered body of the mayenite compound is provided via a fixing metal 69 having a flange projecting from a disk-shaped bottom surface thereof.

A sintered body 71 of the mayenite compound illustrated in FIGS. 29(a) and 29(b) has a cylindrical shape. A sintered body 73 of the mayenite compound illustrated in FIGS. 30(a) and 30(b) has a cylindrical column shape. The sintered body of the mayenite compound illustrated in FIGS. 29(a) and 29(b) may have a bottom on the fixing metal side.

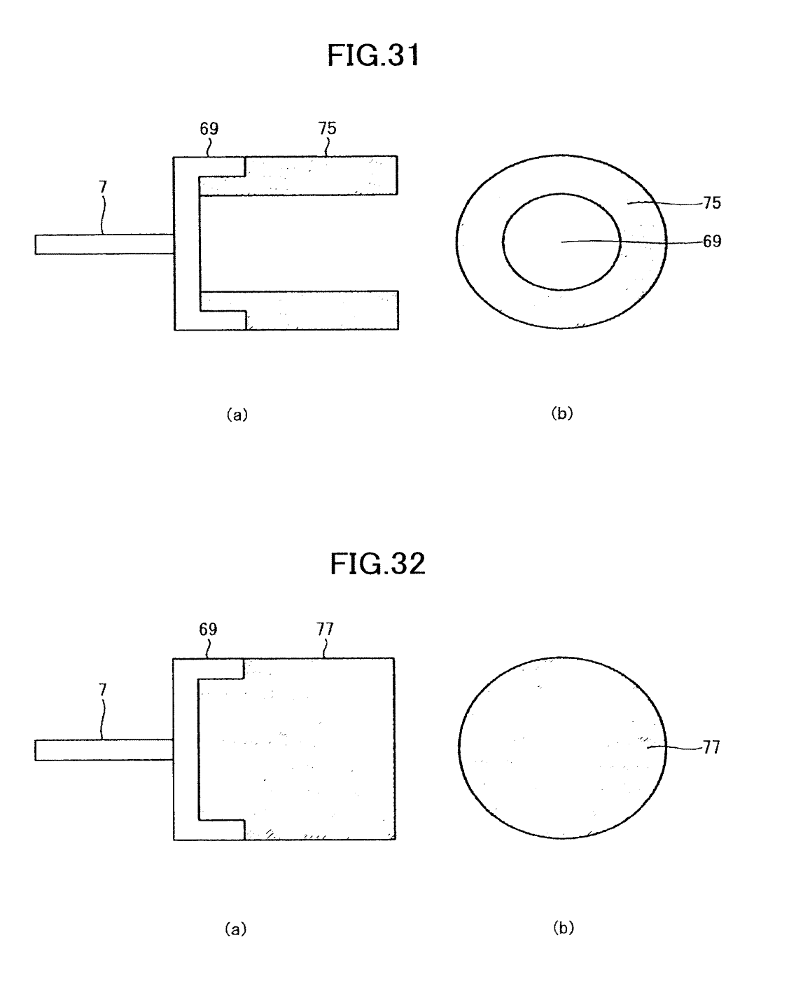

In addition, a sintered body 75 of the mayenite compound illustrated in FIGS. 31(a) and 31(b) and a sintered body 77 of the mayenite compound illustrated in FIGS. 32(a) and 32(b) cover an upper end surface of the flange of the fixing metal 69 and are aligned to an outer periphery of the flange.

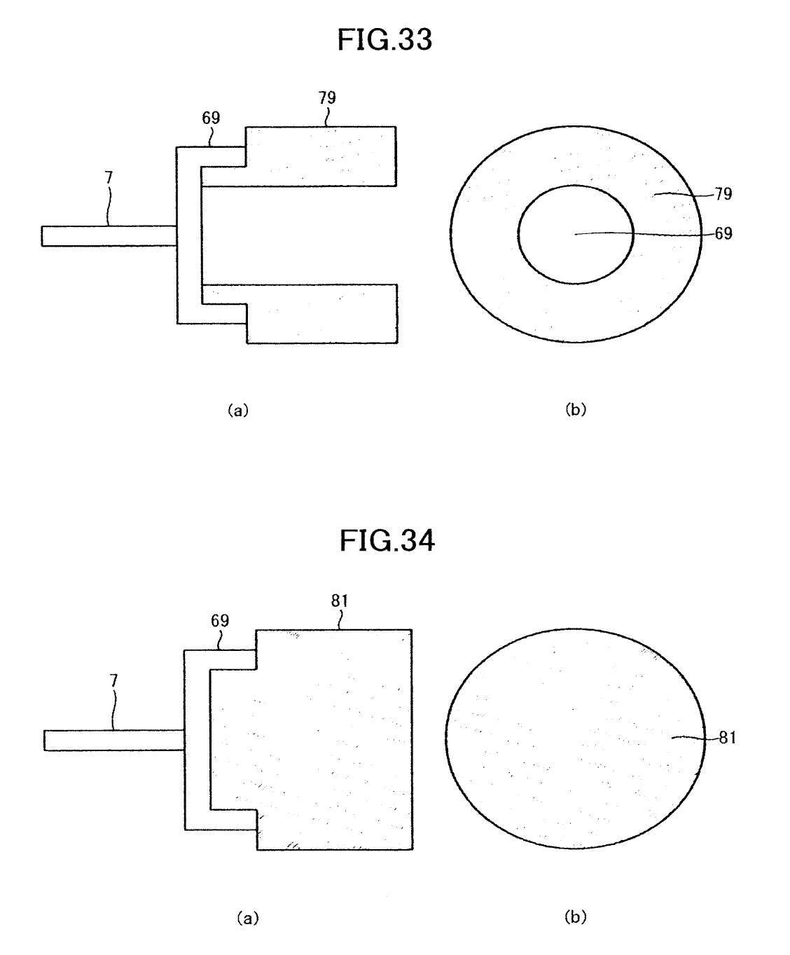

Further, a sintered body 79 of the mayenite compound illustrated in FIGS. 33(a) and 33(b) and a sintered body 81 of the mayenite compound illustrated in FIGS. 34(a) and 34(b) cover the upper end surface of the flange of the fixing metal 69 and project from the outer periphery of the flange.

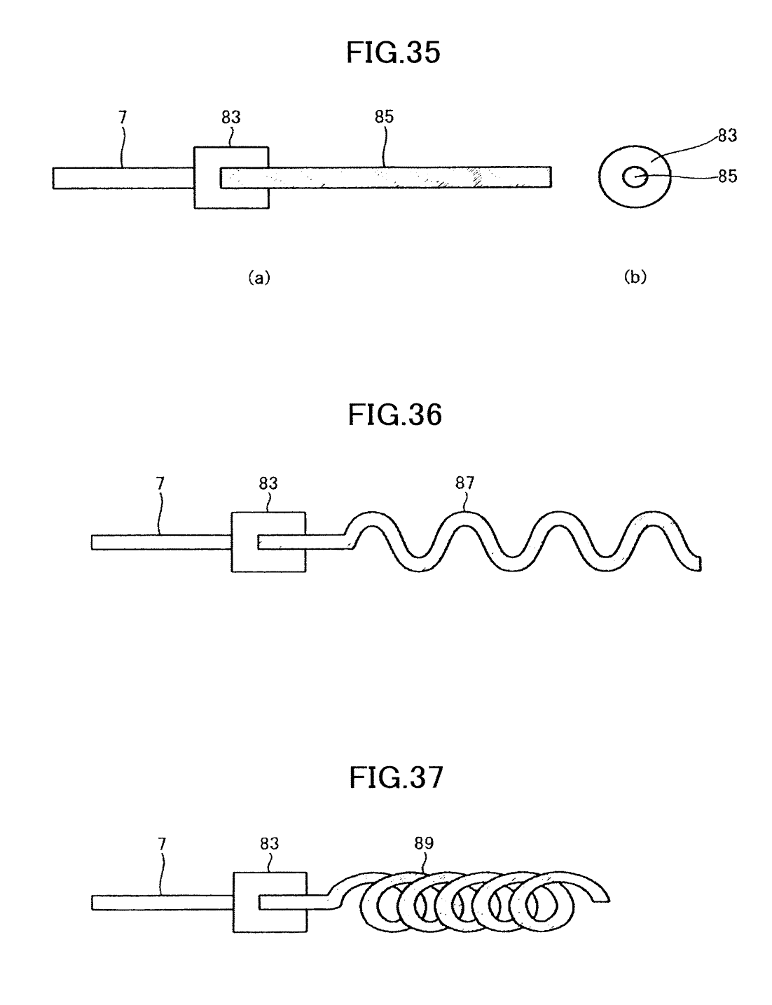

FIG. 35(a)-FIG. 37 illustrate examples in which the wire-shaped electrode is formed solely by the sintered body of the mayenite compound. The wire-shaped electrode is mounted via a fixing metal 83. The wire-shaped electrode may form a linear electrode 85 illustrated in FIG. 35 or, may faun a wave-shaped electrode 87 illustrated in FIG. 36 or, may faun a spiral electrode 89 illustrated in FIG. 37.

Next, examples in which the sintered body of the mayenite compound is provided with respect to an electrode including a plate-shaped fixing bracket are illustrated.

FIG. 38(a) illustrates a plan view, FIG. 38(b) illustrates a side view, and FIG. 38(c) illustrates a bottom view. A sintered body 93 of the mayenite compound, that is foamed to a rectangular shape to match a width of the electrode, may be fixed on a top surface of an electrode 91 including the plate-shaped fixing bracket, as illustrated in FIGS. 38(a)-38(c).

In addition, a sintered body 95 of the mayenite compound may be formed to receive a tip end part of the electrode 91 including the plate-shaped fixing bracket, fitted into the sintered body 95, as illustrated in FIGS. 39(a)-39(c).

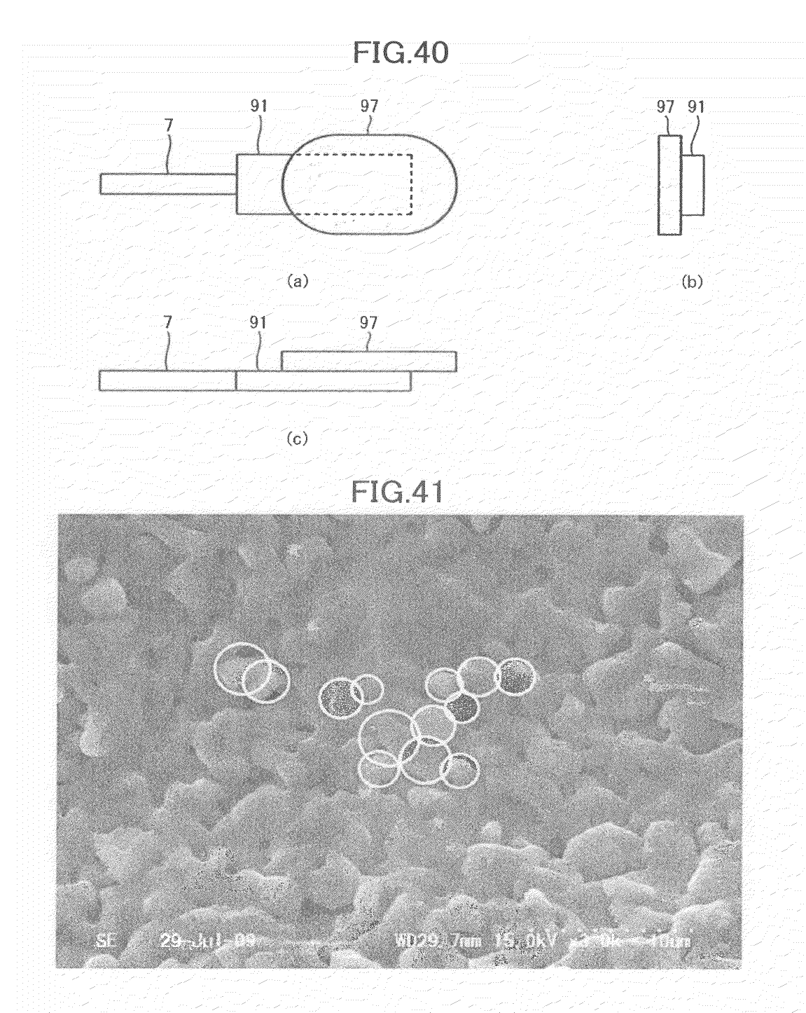

Further, a sintered body 97 of the mayenite compound, that is formed to an oval plate shape exceeding the width of the electrode, may be fixed on the top surface of the electrode 91 including the plate-shaped fixing bracket, as illustrated in FIGS. 40(a)-40(c).

Moreover, the dimensions of the electrode formed from the sintered body may be changed appropriately depending on the configuration of the lamp, however, a length of the electrode is preferably 2 mm to 50 mm. When the manufacturing ease of the sintered body is taken into consideration, the diameter of wire-shaped electrode is preferably 0.1 mm to 3 mm, the width of the plate-shaped electrode is preferably 1 mm to 20 mm and the thickness of the plate-shaped electrode is preferably 0.1 mm to 3 mm, and the outer diameter of the cup-shaped or cylindrical or cylindrical column shaped electrode is preferably 1 mm to 20 mm, and the thickness of the cup-shaped or cylindrical electrode is preferably 0.05 mm to 5 mm.

The atmosphere in which the mayenite compound described above is fired is preferably a reducing atmosphere. The reducing atmosphere means an atmosphere or a depressurized environment in which a reducing agent exists in a portion contacting the atmosphere and an oxygen partial pressure is 10⁻³ Pa or lower. For example, carbon or aluminum powder may be mixed as the reducing agent to the mayenite compound, and the reducing agent may be mixed to a source material (for example, calcium carbonate and aluminum oxide) of the mayenite compound when the mayenite compound is made. In addition, carbon, calcium, aluminum, and titanium may be provided at the part in contact with the atmosphere. In the case in which the reducing agent is carbon, for example, the electrode may be set in a carbon container and fired under vacuum. The oxygen partial pressure is preferably 10⁻⁵ Pa, and more preferably 10⁻¹⁰ Pa, and further more preferably 10⁻¹⁵ Pa. The effect of reducing the cathode fall voltage may be insufficient when the oxygen partial pressure is higher than 10⁻³ Pa.

The temperature at which the mayenite compound is fired is preferably 600° C. to 1415° C., and more preferably 1000° C. to 1370° C., and further more preferably 1200° C. to 1350° C. The effect of reducing the cathode fall voltage may be insufficient and a stable discharge may not be obtained when the firing temperature is lower than 600° C. In addition, melting progresses and it is not preferable in that it may not be possible to maintain the shape of the electrode when the firing temperature is higher than 1415° C.

The time for which the above described temperature is held is preferably 5 minutes to 6 hours, and more preferably 10 minutes to 4 hours, and further more preferably 15 minutes to 2 hours. The effect of reducing the cathode fall voltage may be insufficient and a stable discharge may not be obtained when the temperature holding time is less than 5 minutes. No notable problems occur from the characteristic point of view when the temperature holding time is set long, however, the temperature holding time is preferably 6 hours or less when the manufacturing cost is taken into consideration.

Next, a description will be given of the mayenite compound.

In the present invention, the mayenite compound may be 12CaO—7Al₂O₃ (hereinafter referred to as “C12A7”) formed from calcium (Ca), aluminum (Al) and oxygen (O) and having a cage structure, 12SrO—7Al₂O₃ compound having the calcium of the C12A7 substituted by strontium (Sr), mixed crystal compound of those, and isomorphic compounds having a crystal structure equivalent to those. The mayenite compounds described above have a high resistance to sputtering with respect to ions of the mixed gas described above used in the discharge lamp, and are preferable in that the life of the electrode for the discharge lamp may be lengthened.

The mayenite compounds described above clathrate oxygen ions within respective cages, and at least a part of the cations or anions within the framework or cage may be substituted within a range in which the framework of the crystal lattice of C12A7 and the cage structure formed by the framework may be maintained. The oxygen ions clathrated within the cage are hereinafter referred to as free oxygen ions as it is customary to do so.

For example, in C12A7, a part of Ca may be substituted by atoms of magnesium (Mg), strontium (Sr), barium (Ba), lithium (Li), sodium (Na), copper (Cu), chromium (Cr), manganese (Mn), cerium (Ce), cobalt (Co), nickel (Ni), and the like. In C12A7, a part of Al may be substituted by atoms of silicon (Si), germanium (Ge), boron (B), gallium (Ga), titanium (Ti), manganese (Mn), iron (Fe), cerium (Ce), praseodymium (Pr), terbium (Tb), scandium (Sc), lanthanum (La), yttrium (Y), europium (Eu), ytterbium (Yb), cobalt (Co), nickel (Ni), and the like. Further, in C12A7, oxygen in the cage or framework may be substituted by nitrogen (N) and the like. Of course, the elements that are substituted may not be limited to the elements described above.

In the present invention, at least a part of the free oxygen ions in the mayenite compound may be substituted by electrons.

The following compounds (1)-(4) are particular examples of the mayenite compound, but the mayenite compound is of course not limited to such examples.

(1) Calcium magnesium aluminate (Ca_{1-y}Mg_{y}) ₁₂Al₁₄O₃₃ or calcium strontium aluminate (Ca_{1-z}Sr_{z})₁₂Al₁₄O₃₃, which are mixed crystals in which a part of Ca in the framework of the C12A7 compound is substituted by magnesium or strontium, where y and z are preferably 0.1 or less.

(2) Ca₁₂Al₁₀Si₄O₃₅ which is silicon substitution type mayenite.

(3) For example, Ca₁₂Al₁₄O₃₂:2OH⁻ or Ca₁₂Al₁₄O₃₂:2F⁻, in which the free oxygen ions within the cage are substituted by anions such as H⁻, H²⁻, O⁻, O²⁻, OH⁻, F⁻, Cl⁻, Br⁻, S²⁻, and Au⁻.

(4) For example, wadalite Ca₁₂Al₁₀Si₄O₃₂:6Cl⁻ in which both the cations and anions are substituted.

In a case in which at least a part of the electrode is formed by the sintered body of the mayenite compound, it is preferable that at least a part of the free oxygen ions in the mayenite compound is substituted by electrons, and the electron density is 1×10¹⁹ cm⁻³ or higher. It is not preferable that the electron density is less than 1×10¹⁹ cm⁻³, because the conductivity decreases, a potential distribution is generated when the voltage is applied to the electrodes, and the electrode may not function as the electrode for the discharge lamp. The electron density is more preferably 5×10¹⁹ cm⁻³ or higher, and further more preferably 1×10²⁰ cm⁻³ or higher. A theoretical upper limit of the electron density is 2.3×10²¹ cm⁻³. In this specification, the mayenite compound having the electron density of 1×10¹⁵ cm⁻³ or higher is referred to as a conductive mayenite or, a conductive mayenite compound.

In this specification, the electron density of the conductive mayenite refers to a measured value of the spin density that is measured using an electron spin resonance apparatus or, calculated based on a measurement of an absorption coefficient. Generally, the electron density may preferably be measured using the electron spin resonance apparatus (ESR apparatus) when the measured value of the spin density is lower than 10¹⁹ cm⁻³, and the electron density may be calculated in the following manner when the spin density exceeds 10¹⁸ cm⁻³.

First, a spectrophotometer is used to measure an intensity of light absorption by electrons inside a cage of the conductive mayenite, and the absorption coefficient at 2.8 eV is obtained. Next, the electron density of the conductive mayenite is quantified using that the obtained absorption coefficient is in proportion to the electron density. In addition, if the conductive mayenite compound is powder or the like and it is difficult to carry out the measurement of a transmission spectrum by a photometer, a diffuse reflectance spectrum is measured using an integrating sphere, and the electron density of the conductive mayenite is calculated from the value acquired according to the Kubelka-Munk method.

In the case of the electrode having the metal base and the mayenite compound covering at least a part of the electrode, it is preferable that at least a part of the free oxygen ions in the mayenite compound is substituted by electrons, and the electron density is 1×10¹⁷ cm⁻³ or higher. It is not preferable that the electron density is less than 1×10¹⁷ cm⁻³, because the secondary electron emission may be insufficient and a stable discharge may not occur, and the electrode may not function as the electrode for the discharge lamp. The electron density is more preferably 5×10¹⁷ cm⁻³ or higher, and further more preferably 1×10¹⁸ cm⁻³ or higher. A theoretical upper limit of the electron density is 2.3×10²¹ cm⁻³.

The crystal structure of the mayenite compound is more preferably polycrystalline than monocrystalline. In addition, the polycrystalline powder of the mayenite compound may be sintered. When the mayenite compound is monocrystalline, the performance of the secondary electron emission may deteriorate unless a suitable crystal face is exposed at the surface. In addition, the manufacturing process becomes complex when it is necessary to expose a specific crystal face. The polycrystalline structure is preferable because a decrease in the work function and an improved performance of the secondary electron emission may be expected by the existence of a grain boundary. Further, the electrons scattered at the grain boundary further generate thermoelectrons, field emission electrons, and secondary emission electrons, and the effect of improving the performance of the electron emission may be expected.

The mayenite compound carried by the electrode may include, within the grain of the polycrystalline structure of the mayenite compound or bulk, a compound other than the mayenite compound, including calcium aluminate such as CaO—Al₂O₃ and 3Ca—Al₂O₃, calcium oxide CaO, and aluminum oxide Al₂O₃, and the like. However, in order to efficiently emit the secondary electrons from the surface of the electrode for the discharge lamp, it is preferable that the mayenite compound existing within the grain of the polycrystalline structure of the mayenite compound or bulk is 50 volume % or greater.

When the mayenite compound is fired in the vacuum atmosphere with the oxygen partial pressure of 10⁻³ Pa or less, the inert gas atmosphere with the oxygen partial pressure of 10⁻³ Pa or less, or the reducing atmosphere with the oxygen partial pressure of 10⁻³ Pa or less under the above conditions, a surface shape of the sample changes due to crystal redeposition. The crystal that is deposited may be that of the mayenite compound or, the crystal of a constituent element.

FIG. 41 illustrates, as an example, a surface state of the sintered body of the conductive mayenite compound that is formed from mayenite compound powder, when observed using a Scanning Electron Microscope (SEM) (with a magnification of 3000 times).

As may be seen from FIG. 41, the sintered body of the conductive mayenite compound has a cluster structure having many neck parts formed by particles being joined with each other, and the surface has a three-dimensional concavo-convex structure comprised of the particles protruding partially. Here, the “particles” may not necessarily refer to the mayenite compound powder before being sintered, and may also refer to parts that have a granular shape when the sintered body is observed.

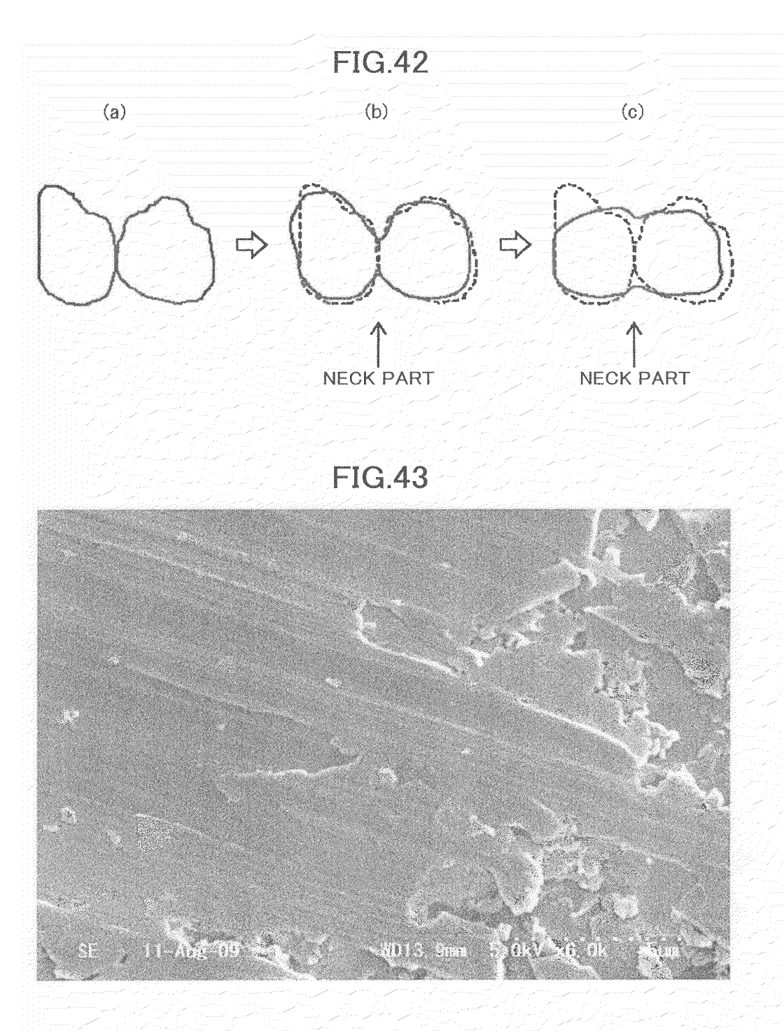

A schematic description will be given of a process of foaming the characteristic surface state, by referring to FIGS. 42(a)-42(c). FIGS. 42(a)-42(c) are schematic diagrams illustrating an example of the process of foaming the neck part of the sintered body of the conductive mayenite compound.

First, when two particles arranged as illustrated in FIG. 42(a) are subjected to the sintering process, bonding illustrated by a solid line in FIG. 42(b) is produced. In addition, when the bonding of the particles progresses, a structure illustrated by a solid line in FIG. 42(c) is obtained. In FIG. 42(b) and FIG. 42(c), a portion in which the particles are combined with each other corresponds to the neck part. In FIG. 42(b) and FIG. 42(c), dotted lines illustrates particle shapes before the sintering process (that is, the shape of FIG. 42(a)) for comparison purposes.

When the bonding between the particles progresses among the particles, the cluster structure is formed as a whole. In the surface of the cluster structure (particularly on the discharge space side), a three-dimensional concavo-convex structure in which particles are partially protruded, is obtained.

In the state illustrated in FIG. 42(c), the bonding between the neck parts also progresses, the particles may appear to be distributed inside a dense part having relatively flat and smooth surface, and the particles may appear to be partially protruded from the surface.

The structure of the sintered body illustrated in FIG. 41 is formed in the process of firing the particles, and it may be inferred that a complex phenomenon is involved caused by the redeposition of the mayenite compound or the crystal of another constituent element of the mayenite compound at the surface of the sintered body, and by the simultaneous sintering of the mayenite compound powder.

In addition, when the sintered body having the surface structure of FIG. 41 is used as the electrode material, the surface area greatly increases to thereby enable more secondary electron emission, and a large current may more easily be obtained. For this reason, compared to the electrode formed by the conventional single crystal conductive mayenite compound, an extremely good performance of the secondary electron emission may be obtained.

Accordingly, the sintered body of the conductive mayenite compound in the present invention may be used effectively for the electrode of the fluorescent lamp or the like. In addition, the present invention may obtain the effect of making the method of manufacturing the electrode extremely simple.

In the surface state illustrated in FIG. 41, a dimension of the protruding part illustrated by a circular mark (hereinafter referred to as a “domain diameter”) is on the order of approximately 0.1 μm to 10 μm, for example. The magnitude and distribution of the domain diameter greatly vary depending on the manufacturing method. When the domain diameter is less than 0.1 μm or, when the domain diameter is greater than 10 μm, the effect of increasing the surface area may be insufficient, and a sufficient performance of the secondary electron emission may not be obtained.

As an example, the manner in which the surface shape changes due to the firing will be illustrated. FIG. 43 is an electron micrograph illustrating a polished surface of a sample of the sintered body of the mayenite compound that is cut and polished in the form of a pellet having a diameter of 8 mmØ and a thickness of 2 mm, and observed on the SEM with a magnification of 6000 times, for example. It may be seen that marks of the polishing remain, and a part of the surface appears as being scraped off. In this state, the three-dimensional concavo-convex structure may not be observed.

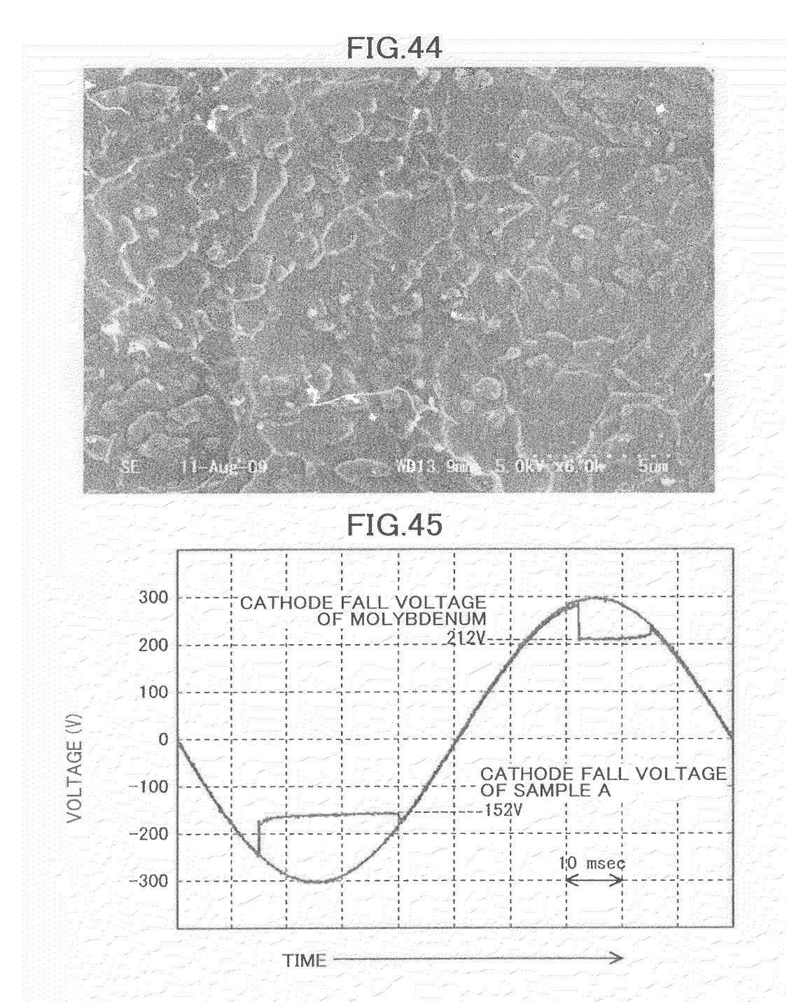

FIG. 44 is an electron micrograph illustrating the surface of the sample of the sintered body of the mayenite compound after the sample is set within the carbon container with a lid, maintained at 1300° C. for 6 hours under a vacuum atmosphere of 10⁻⁴ Pa, and observed on the SEM with a magnification of 6000 times. It was observed that the surface once melts and becomes dense, and the crystal redeposition occurs thereafter. In other words, formation of the three-dimensional concavo-convex structure was observed. In FIG. 44, it may be seen that the grain structure having a domain diameter of 0.2 μm to 3 μm is generated.

Accordingly, by firing in the vacuum atmosphere with the oxygen partial pressure of 10⁻³ Pa or less, the inert gas atmosphere with the oxygen partial pressure of 10⁻³ Pa or less, or the reducing atmosphere with the oxygen partial pressure of 10⁻³ Pa or less, the shape of the sample surface changes due to the crystal redeposition, and the cathode fall voltage may be reduced.

Next, a description will be given of the method of manufacturing the electrode for the discharge lamp, having a low cathode fall voltage. One aspect of the present invention provides a manufacturing method in which a part of or the entire electrode is formed by the mayenite compound, and the mayenite compound is thereafter fired in the vacuum atmosphere with the oxygen partial pressure of 10⁻³ Pa or less, the inert gas atmosphere with the oxygen partial pressure of 10⁻³ Pa or less, or the reducing atmosphere with the oxygen partial pressure of 10⁻³ Pa or less. Although the manufacturing method of the present invention is described by way of an example, the present invention is of course not limited to the example.

In the case in which the electrode for the discharge lamp includes the metal base and the mayenite compound is provided on at least a part of the metal base, the mayenite compound may cover the metal base of the electrode. Examples of the method of covering the mayenite compound may include a method that carries out a normally used wet process in order to mix the mayenite compound in the powder foist to a solvent, a binder, and the like, before coating the mayenite compound to a desired part using spray coating, spin coating, dip coating, or screen printing, and a method that deposits the mayenite compound on at least a part of the electrode for the discharge lamp using physical vapor deposition method such as vacuum deposition, electron beam deposition, sputtering, or thermal spraying, etc.

More particularly, a slurry including the solvent and the binder is adjusted and coated on the surface of the electrode for the discharge lamp by dip coating or the like. A heat treatment is carried out at 50° C. to 200° C. and maintained for 30 minutes to 1 hour in order to remove the solvent, and a heat treatment is carried out at 200° C. to 800° C. and maintained for 20 minutes to 30 minutes in order to remove the binder.

The mayenite compound powder used in the above described method may be manufactured by grinding, for example. The grinding preferably performs a coarse grinding before performing a fine grinding. The coarse grinding may grind the mayenite compound or a material including the mayenite compound into particle sizes on the order of 20 μm in average particle diameter, using a stamp mill, an automatic mortar grinder, or the like. The fine grinding may grind the mayenite compound or the material including the mayenite compound into particle sizes on the over of 5 μm in average particle diameter, using a ball mill, a bead mill, or the like. The grinding may be performed in an atmospheric ambient or, within an inert gas.

In addition, the grinding may be performed within a solvent including no moisture. Examples of a preferable solvent may include an alcohol-based solvent and an ether-based solvent respectively having 3 or more carbon atoms. The grinding is facilitated by the use of such solvents, and thus, the grinding may use one of such solvents or a mixture of such solvents. When the solvent used for the grinding is a compound having a hydroxyl group with 1 or 2 carbon atoms, such as alcohols and ether, the mayenite compound may react with the compound solvent and become decomposed, which is not preferable. Hence, when the solvent is used at the time of the grinding, the solvent may be volatile by heating to 50° C. to 200° C. in order to obtain the powder.

After the mayenite compound is coated on the electrode including the metal base using the method described above, it is preferable to carry out a heat treatment at 600° C. to 1415° C. for a holding time on the order of 5 minutes to 6 hours in an environment in which the metal part of the electrode will not be oxidized, including an inert gas atmosphere such as a nitrogen gas, a vacuum atmosphere, and a reducing atmosphere, in order to strongly bond the mayenite compound on the metal base of the electrode.

The reducing atmosphere means an atmosphere or a depressurized environment in which a reducing agent exists in a portion contacting the atmosphere and an oxygen partial pressure is 10⁻³ Pa or lower. For example, carbon or aluminum powder may be mixed as the reducing agent to the mayenite compound, and the reducing agent may be mixed to a source material (for example, calcium carbonate and aluminum oxide) of the mayenite compound when the mayenite compound is made. In addition, carbon, calcium, aluminum, and titanium may be provided at the part in contact with the atmosphere. In the case in which the reducing agent is carbon, for example, the electrode coated with the mayenite compound may be set in a carbon container and fired under vacuum. It is preferable to carry out a heat treatment under the reducing atmosphere, because the free oxygen ions of the mayenite compound may be substituted by the electrons.

Furthermore, in the case in which the heat treatment temperature is 1200° C. to 1415° C., which is the temperature at which the mayenite compound is synthesized, and C12A7 is used as the mayenite compound, for example, a calcium compound and an aluminum compound may be mixed and adjusted to a mole fraction of 12:7 in an oxide scale, and thereafter mixed in an equipment such as a ball mill. The resulting mixture may be mixed with a solvent, a binder, and the like in order to obtain a slurry or a paste to be coated. According to this method, the manufacturing of the mayenite compound and the manufacturing of the sintered body of the mayenite compound powder may be achieved simultaneously.

Next, a description will be given of a case in which the electrode is formed by the sintered body of the mayenite compound. When forming the electrode by the sintered body of the mayenite compound, at least a part of the free oxygen ions of the mayenite compound needs to be substituted by the electrons, and the density of the electrons needs to be 1×10¹⁹ cm⁻³ or higher.

For this reason, the sintered body is preferably manufactured by forming the slurry or paste of the mayenite compound powder in advance so that it becomes a desired shape, such as the electrode or a part thereof, after the sintering, and firing the shaped slurry or paste under the condition that at least a part of the free oxygen ions is substituted by the electrons, that is, under the reducing atmosphere in which the oxygen partial pressure is 10⁻³ Pa or less.

The sintered body may be subjected to a process after the firing if necessary. In this case, the sintered body after the process needs to be fired again under the reducing atmosphere in which the oxygen partial pressure is 10⁻³ Pa or less. However, the sintered body before the process may be manufactured in air.

The sintering of the mayenite compound powder is preferably carried out by forming the powder or the slurry or paste formed from the powder into a desired shape by press molding, injection molding, extrusion molding, or the like, and firing a molded body in the reducing atmosphere in which the oxygen partial pressure is 10⁻³ Pa or less.

The powder may be formed into the paste or slurry by mixing thereto a binder such as polyvinyl alcohol or, by supplying only the powder into a pressing machine and applying pressure to thereby form a green compact. However, the shape of the molded body needs to take into consideration a shrinkage of the shape caused by the firing.

For example, polyvinyl alcohol may be mixed, as the binder, to the mayenite compound powder having an average particle diameter of 5 μm and pressed using a desired die in order to obtain the molded body. When forming the molded body using the paste or slurry including the binder, it is preferable to remove the binder by maintaining 200° C. to 800° C. for 20 minutes to 30 minutes before firing the molded body.

The environment in which the molded body is fired needs to be the reducing atmosphere described above in order to substitute at least a part of the free oxygen ions by the electrons. The reducing atmosphere means an atmosphere or a depressurized environment in which a reducing agent exists in a portion contacting the atmosphere and an oxygen partial pressure is 10⁻³ Pa or lower. For example, carbon or aluminum powder may be mixed as the reducing agent to the source material of the mayenite compound when the mayenite compound is made. In addition, carbon, calcium, aluminum, and titanium may be provided at the part in contact with the environment. In the case in which the reducing agent is carbon, for example, the molded body may be set in the carbon container and sintered under vacuum.

The oxygen partial pressure is preferably 10⁻⁵ Pa, and more preferably 10⁻¹⁰ Pa, and further more preferably 10⁻¹⁵ Pa. When the oxygen partial pressure is 10⁻³ Pa, it is not preferable in that a sufficient conductivity may not be obtained. The heat treatment temperature is preferably 1200° C. to 1415° C., and more preferably 1250° C. to 1350° C. When the heat treatment temperature is lower than 1200° C., the sintering does not progress and it is not preferable in that the sintered body becomes fragile. In addition, when the heat treatment temperature is higher than 1415° C., melting progresses and it is not preferable in that the shape of the molded body may not be maintained. The time for which the heat treatment temperature described above is to be maintained may be adjusted so that the sintering of the molded body may be completed.

The time for which the heat treatment temperature is to be maintained is preferably 5 minutes to 6 hours, and more preferably 30 minutes to 4 hours, and further more preferably 1 hour to 3 hours. When the time for which the heat treatment temperature is to be maintained is 5 minutes or less, it is not preferable in that a sufficient conductivity may not be obtained. A time longer than the above preferable times does not introduce a problem from the point of view of characteristics, however, the time is preferably 6 hours or less when the manufacturing cost is taken into consideration.

The sintered body in the present invention may be manufactured by forming a molded body from a composite powder of calcium compound, aluminum compound, calcium aluminate, and the like, and carrying out the firing under the above described conditions. Because 1200° C. to 1415° C. is the temperature at which the mayenite compound is synthesized, the sintered body of the conductive mayenite compound may be obtained. According to this method, the manufacturing of the mayenite compound and the manufacturing of the sintered body of the mayenite compound powder may be achieved simultaneously.

The sintered body obtained by the above described method may be subjected to a process in order to be formed into a desired shape if necessary. The method of processing the sintered body into the desired electrode shape is not limited to a particular method. However, examples of the method may include machining, electrical discharge machining, laser beam machining, and the like. The electrode for the discharge lamp according to the present invention may be obtained by processing the shape of the electrode for the discharge lamp to a desired shape, such as a cup shape, a strip shape, a flat plate shape, and the like, and thereafter performing the firing in the reducing atmosphere with the oxygen partial pressure of 10⁻³ Pa or less.

After the mayenite compound is fired in the vacuum atmosphere with the oxygen partial pressure of 10⁻³ Pa or less, the inert gas atmosphere with the oxygen partial pressure of 10⁻³ Pa or less, or the reducing atmosphere with the oxygen partial pressure of 10⁻³ Pa or less, the sintered mayenite compound is preferably not exposed to the atmospheric ambient. This is because the surface at the surface layer of the mayenite compound after the firing, when exposed to oxygen and water vapor within the atmosphere environment, may change the surface state thereof and deteriorate the performance of the secondary electron emission. Accordingly, it is particularly desirable to manufacture the product in a state in which the mayenite compound fired in the vacuum atmosphere with the oxygen partial pressure of 10⁻³ Pa or less, the inert gas atmosphere with the oxygen partial pressure of 10⁻³ Pa or less, or the reducing atmosphere with the oxygen partial pressure of 10⁻³ Pa or less, is not exposed to the atmosphere environment.

The electrode provided with the mayenite compound 9 fired in the vacuum atmosphere with the oxygen partial pressure of 10⁻³ Pa or less, the inert gas atmosphere with the oxygen partial pressure of 10⁻³ Pa or less, or the reducing atmosphere with the oxygen partial pressure of 10⁻³ Pa or less, may be mounted within the glass tube 1 without being exposed to air. In addition, the atmosphere may be replaced by the discharge gas in a state in which the mayenite compound 9 is arranged inside the glass tube 1 in advance. The discharge gas may be sealed without exposing the mayenite compound 9 to the atmosphere. In this case, the mayenite compound 9 may be fired in the vacuum atmosphere with the oxygen partial pressure of 10⁻³ Pa or less, the inert gas atmosphere with the oxygen partial pressure of 10⁻³ Pa or less, or the reducing atmosphere with the oxygen partial pressure of 10⁻³ Pa or less.

According to the present invention, it is possible to provide the discharge lamp having the above described electrode for the discharge lamp, or the electrode for the discharge lamp manufactured according to the above described method of manufacturing the electrode for the discharge lamp. The discharge lamp of the present invention includes the mayenite compound in at least a part of the electrode for the discharge lamp, and this mayenite compound is fired in the vacuum atmosphere with the oxygen partial pressure of 10⁻³ Pa or less, the inert gas atmosphere with the oxygen partial pressure of 10⁻³ Pa or less, or the reducing atmosphere with the oxygen partial pressure of 10⁻³ Pa or less, and for this reason, the cathode fall voltage is low and the power consumption is low.

In addition, the life of the electrode for the discharge lamp may be lengthened because the resistance thereof to sputtering is improved. More particularly, by subjecting the mayenite compound forming at least a part of the cold cathode to the firing in the vacuum atmosphere with the oxygen partial pressure of 10⁻³ Pa or less, the inert gas atmosphere with the oxygen partial pressure of 10⁻³ Pa or less, or the reducing atmosphere with the oxygen partial pressure of 10⁻³ Pa or less, it becomes possible to provide a cold cathode fluorescent lamp having a cathode fall voltage that is lower than that for cases in which nickel, molybdenum, tungsten, niobium, and alloy of iridium and rhodium are used for the cold cathode. Furthermore, the life of the cold cathode fluorescent lamp of the present invention may be lengthened because the resistance of the cold cathode to the sputtering is improved.

Moreover, according to the present invention, it is possible to provide a discharge lamp provided with a fluorescent tube, a discharge gas sealed inside the discharge lamp, and a mayenite compound provided inside the discharge lamp at a part making contact with the discharge gas, wherein mayenite compound is fired in the vacuum atmosphere with the oxygen partial pressure of 10⁻³ Pa or less, the inert gas atmosphere with the oxygen partial pressure of 10⁻³ Pa or less, or the reducing atmosphere with the oxygen partial pressure of 10⁻³ Pa or less.

More particularly, it is possible to provide the cold cathode fluorescent lamp illustrated in FIG. 1. The cold cathode fluorescent lamp includes the fluorescent tube having the phosphor 3 coated on the inner surface of the glass tube 1, and the discharge gas sealed inside the cold cathode fluorescent lamp and including argon (Ar), neon (Ne), and mercury (Hg) for exciting the phosphor.

In addition, the electrodes 5A and 5B forming cup-shaped cold cathodes arranged in pairs symmetrically inside the glass tube 1 is covered or coated with the mayenite compound. The mayenite compound may be mixed into the phosphor 3, and may be arranged within the cold cathode fluorescent lamp at a position subjected to the plasma generated by the discharge.

Such a cold cathode fluorescent lamp has a cathode fall voltage lower than that of the fluorescent lamp using nickel, molybdenum, tungsten, niobium, and alloy of iridium and rhodium for the cold cathode, which results in a lower power consumption. Further, the life of such a cold cathode fluorescent lamp is lengthened because the resistance of the cold cathode to the sputtering is improved.

### Practical Examples

<Manufacture of Mayenite Compound>

Calcium carbonate and aluminum oxide were mixed and adjusted to a mole fraction of 12:7, and maintained at 1300° C. for 6 hours in air in order to manufacture a bulk of 12CaO—7Al₂O₃ compound. This bulk was set in a carbon container with a lid, and maintained at 1300° C. for 2 hours in a nitrogen atmosphere with an oxygen partial pressure of 10⁻³ Pa or less, in order to obtain a dark green bulk. An automatic mortar grinder was used to grind this bulk in order to obtain powder A1.

The particle size of this powder A1 was measured by a laser diffraction scattering method (SALD-2100 manufactured by Shimadzu Corporation), and the average particle diameter was 20 μm. It was found from an X-ray diffraction that the powder A1 includes only the 12CaO—7Al₂O₃ structure. In addition, the electron density measured from the diffuse reflectance spectrum by the Kubelka-Munk method was 1.0×10¹⁹ cm⁻³. It was found that the powder A1 is a conductive mayenite compound.

<Manufacture of Mayenite Compound Paste>

Next, a wet ball mill was used to further grind the powder A1 using isopropyl alcohol as the solvent. After the grinding, the powder A1 was subjected to suction filtration and dried in air at 80° C. in order to obtain powder A2. The average particle diameter of the powder A2 measured by the laser diffraction scattering method described above was 5 μm. Butyl carbitol acetate, terpineol, and ethylcellulose were added to the powder A2 with a weight ratio so that [powder A2]:[butyl carbitol acetate]:[terpineol]:[ethylcellulose] becomes 6:2.4:1.2:0.4 and kneaded by the automatic mortar grinder, and further subjected to a precision mixing using a centrifugal mixer in order to obtain a paste A.

<Coating of Mayenite Compound>

Next, the paste A was coated on a nickel metal substrate that is commercially available using screen printing. The nickel metal substrate used had a square size with a side of 15 mm, a thickness of 1 mm, and a purity of 99.9%. The nickel metal substrate was subjected to ultrasonic cleaning using isopropyl alcohol and dried by nitrogen blow, before being used. The paste A was coated to a square having a side of 10 mm by the screen printing. The paste A was coated to a thickness of 50 μm before being dried.

Further, the paste A was maintained at 80° C. for 2 hours in order to obtain a dry layer A by drying an organic solvent. The thickness of the dry layer A was 30 μm. It was found from an X-ray diffraction that the dry layer includes only the 12CaO—7Al₂O₃ structure, and the dry layer is a mayenite compound. In addition, the electron density measured from the diffuse reflectance spectrum by the Kubelka-Munk method was 1.0×10¹⁹ cm⁻³.

<Firing of Mayenite Compound>

Next, the dry layer A on the nickel metal substrate was subjected to a surface treatment. The nickel metal substrate coated with the dry layer A was set on an alumina plate, and the alumina plate carrying the nickel metal substrate was set in a carbon container with a lid. The carbon container was exhausted to 10⁻⁴ Pa, and heated to 500° C. in 15 minutes. This state was maintained for 30 minutes in order to remove the binder, and then further heated to 1300° C. in 24 minutes. After the heat treatment at 1300° C. for 30 minutes, a quick cooling was made to room temperature in order to obtain a sample A, which is the nickel metal substrate coated with the mayenite compound. The coated part of the sample A appeared green in color. The film thickness of the coated part of the sample A was 20 μm. It was found from an X-ray diffraction that the sample A includes only the 12CaO—7Al₂O₃ structure, and was the mayenite compound. In addition, the electron density of the mayenite compound at the coated part measured from the diffuse reflectance spectrum by the Kubelka-Munk method was 2.0×10¹⁹ cm⁻³. In addition, the surface state of the mayenite compound observed on the SEM with a magnification of 6000 times had a three-dimensional concavo-convex structure having a domain diameter of 0.1 μm to 6 μm.

<Measurement of Cathode Fall Voltage>

The cathode fall voltage was measured using an open cell discharge measuring apparatus. For example, the open cell discharge measuring apparatus illustrated in FIG. 2 was used. In an open cell discharge measuring apparatus 30, two samples (sample 1 and sample 2) oppose each other within a vacuum chamber 31, and an AC or DC voltage is applied between the two samples after filling a noble gas such as argon, and a mixed gas of the noble gas and hydrogen. The cathode fall voltage was measured by causing a discharge between the samples. In this state, the cold cathode, which is the sample, may have the shape of any one of the cup-shaped cold cathode, the strip-shaped cold cathode, the flat plate-shaped cold cathode, and cold cathodes having other shapes.

### Practical Example 1

<Measurement of Cathode Fall Voltage (Part 1)>

The sample A was set in the vacuum chamber 31 of the open cell discharge measuring apparatus 30 illustrated in FIG. 2. Molybdenum metal was used for the opposing electrode. A distance between the sample A and the electrodes was 1.45 mm. The vacuum chamber 31 was initially exhausted to 3×10⁻⁴ Pa before filling argon gas again to 4400 Pa.

Next, as illustrated in FIG. 45, an AC voltage of 600 V peak-to-peak at 10 Hz was applied to cause a glow discharge. The measured cathode fall voltage of the sample A was 152 V when a product Pd is approximately 4.8 Torr.cm, where P denotes the gas pressure within the vacuum chamber and d denotes the distance between the cathode and the anode. On the other hand, the cathode fall voltage for the molybdenum metal was 212 V. Accordingly, it was confirmed that the cathode fall voltage of the sample A is 28% lower with respect to that of the molybdenum metal.

### Practical Example 2

<Measurement of Cathode Fall Voltage (Part 2)>

A sample B was obtained in a manner similar to that of the above <Firing of Mayenite Compound>, except for a heat treatment that was carried out at 1340° C. The coated part of the sample B appeared green in color. It was found from an X-ray diffraction that the sample B includes only the 12CaO—7Al₂O₃ structure, and was the mayenite compound. In addition, the electron density of the mayenite compound at the coated part measured from the diffuse reflectance spectrum by the Kubelka-Munk method was 5.8×10¹⁹ cm⁻³. The surface state of the mayenite compound observed on the SEM with a magnification of 6000 times had a three-dimensional concavo-convex structure having a domain diameter of 0.1 μm to 5 μm.

Thereafter, the sample B was set in the vacuum chamber 31 of the open cell discharge measuring apparatus 30 illustrated in FIG. 2. Molybdenum metal was used for the opposing electrode. The distance between the sample B and the opposing electrode was 1.13 mm. The vacuum chamber 31 was exhausted to 3×10⁻⁴ Pa before filling argon gas again to 5300 Pa.

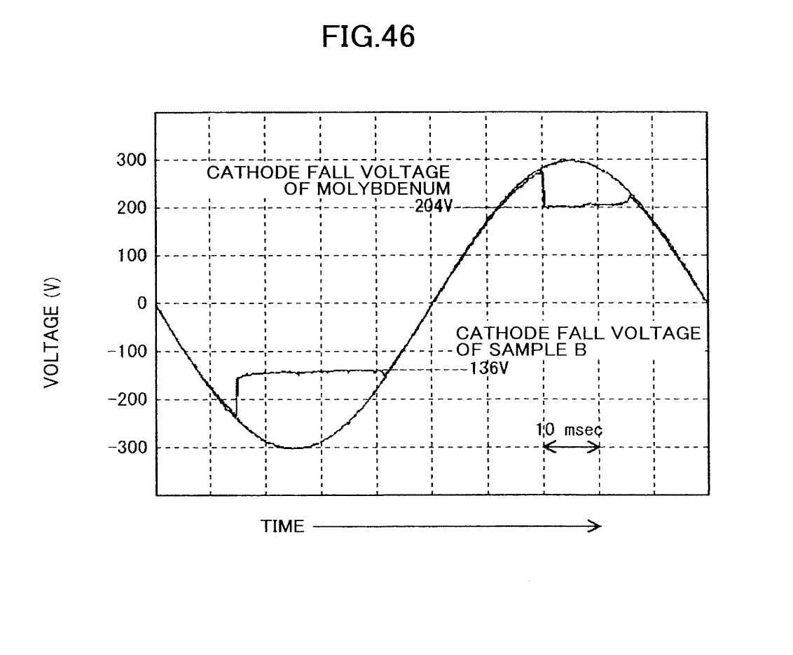

Next, as illustrated in FIG. 46, an AC voltage of 600 V peak-to-peak at 10 Hz was applied to cause a glow discharge. The measured cathode fall voltage of the sample B was 136 V when the product Pd is approximately 4.5 Torr.cm. On the other hand, the cathode fall voltage for the molybdenum metal was 204 V. Accordingly, it was confirmed that the cathode fall voltage of the sample B is 33% lower with respect to that of the molybdenum metal.

### Practical Example 3

<Measurement of Cathode Fall Voltage (Part 3)>

A sample C was obtained in a manner similar to that of the above <Firing of Mayenite Compound>, except for a heat treatment that was maintained at 1300° C. for 2 hours. The coated part of the sample C appeared green in color. It was found from an X-ray diffraction that the sample C includes only the 12CaO—7Al₂O₃ structure, and was the mayenite compound. In addition, the electron density of the mayenite compound at the coated part measured from the diffuse reflectance spectrum by the Kubelka-Munk method was 3.2×10¹⁹ cm⁻³. The surface state of the mayenite compound observed on the SEM with a magnification of 6000 times had a three-dimensional concavo-convex structure having a domain diameter of 0.2 μm to 6 μm.

Thereafter, the sample C was set in the vacuum chamber 31 of the open cell discharge measuring apparatus 30 illustrated in FIG. 2. Molybdenum metal was used for the opposing electrode. The distance between the sample C and the opposing electrode was 1.45 mm. The vacuum chamber 31 was exhausted to 3×10⁻⁴ Pa before filling argon gas again to 4400 Pa.

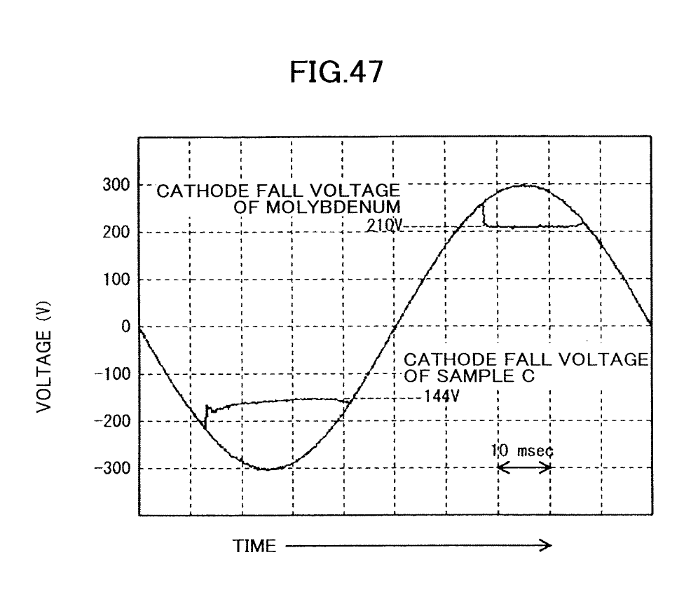

Next, as illustrated in FIG. 47, an AC voltage of 600 V peak-to-peak at 10 Hz was applied to cause a glow discharge. The measured cathode fall voltage of the sample C was 144 V when the product Pd is approximately 4.8 Torr.cm. On the other hand, the cathode fall voltage for the molybdenum metal was 210 V. Accordingly, it was confirmed that the cathode fall voltage of the sample C is 31% lower with respect to that of the molybdenum metal.

### Practical Example 4

<Measurement of Cathode Fall Voltage (Part 4)>

A sample D was obtained in a manner similar to that of the above <Firing of Mayenite Compound>, except for the dry layer A that is formed to a thickness of 10 μm.

The coated part of the sample D appeared approximately transparent. It was found from an X-ray diffraction that the sample D includes only the 12CaO—7Al₂O₃ structure, and was the mayenite compound. In addition, the electron density of the mayenite compound at the coated part measured by the ESR apparatus was 7.0×10¹⁸ cm⁻³. The surface state of the mayenite compound observed on the SEM with a magnification of 6000 times had a three-dimensional concavo-convex structure having a domain diameter of 0.2 μm to 6 μm.

Thereafter, the sample D was set in the vacuum chamber 31 of the open cell discharge measuring apparatus 30 illustrated in FIG. 2. Molybdenum metal was used for the opposing electrode. The distance between the sample D and the opposing electrode was 1.47 mm. The vacuum chamber 31 was exhausted to 3×10⁻⁴ Pa before filling argon gas again to 900 Pa.

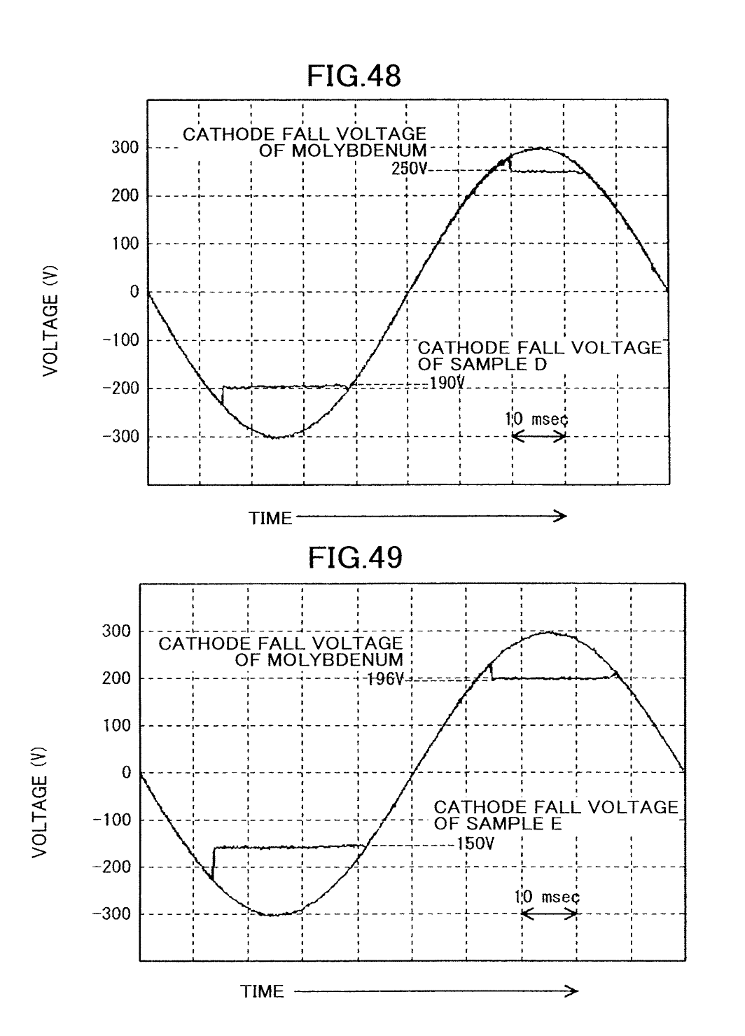

Next, as illustrated in FIG. 48, an AC voltage of 600 V peak-to-peak at 10 Hz was applied to cause a glow discharge. The measured cathode fall voltage of the sample D was 190 V when the product Pd is approximately 1.0 Torr.cm. On the other hand, the cathode fall voltage for the molybdenum metal was 250 V. Accordingly, it was confirmed that the cathode fall voltage of the sample D is 24% lower with respect to that of the molybdenum metal.

### Practical Example 5

<Measurement of Cathode Fall Voltage (Part 5)>

Calcium carbonate and aluminum oxide were mixed and adjusted to a mole fraction of 12:7, and maintained at 1300° C. for 6 hours in air in order to manufacture a bulk that is white in color. An automatic mortar grinder was used to grind this bulk, and a wet ball mill was used to further grind the bulk using isopropyl alcohol as the solvent. After the grinding, a suction filtration, and a drying in air at 80° C. were performed in order to obtain a powder B1 that is white in color. The particle size of this powder B1 was measured by a laser diffraction scattering method (SALD-2100 manufactured by Shimadzu Corporation), and the average particle diameter was 5 μm. It was found from an X-ray diffraction that the powder B1 includes only the 12CaO—7Al₂O₃ structure. In addition, the electron density that is measured using the electron spin resonance (ESR) apparatus was 1.0×10¹⁴ cm⁻³ or less.

A sample E was obtained in a manner similar to that of the above <Firing of Mayenite Compound>, except for the powder B1 was used in place of the powder A1. The coated part of the sample E appeared light green in color. It was found from an X-ray diffraction that the sample E includes only the 12CaO—7Al₂O₃ structure, and was the mayenite compound. In addition, the electron density of the mayenite compound at the coated part measured from the diffuse reflectance spectrum by the Kubelka-Munk method was 6.4×10¹⁸ cm⁻³. The surface state of the mayenite compound observed on the SEM with a magnification of 6000 times had a three-dimensional concavo-convex structure having a domain diameter of 0.1 μm to 5 μm.

Thereafter, the sample E was set in the vacuum chamber 31 of the open cell discharge measuring apparatus 30 illustrated in FIG. 2. Molybdenum metal was used for the opposing electrode. The distance between the sample E and the opposing electrode was 1.47 mm. The vacuum chamber 31 was exhausted to 3×10⁻⁴ Pa before filling argon gas again to 2260 Pa.

Next, as illustrated in FIG. 49, an AC voltage of 600 V peak-to-peak at 10 Hz was applied to cause a glow discharge. The measured cathode fall voltage of the sample E was 150 V when the product Pd is approximately 2.5 Torr.cm. On the other hand, the cathode fall voltage for the molybdenum metal was 196 V. Accordingly, it was confirmed that the cathode fall voltage of the sample E is 23% lower with respect to that of the molybdenum metal.

### Practical Example 6

<Measurement of Cathode Fall Voltage (Part 6)>

1weight % of polyvinyl alcohol was added to the powder A2 obtained by the above <Manufacture of Mayenite Compound Paste> and kneaded, and a molded body of 2×2×2 cm³ was obtained by uniaxial press molding. This molded body was heated to 1350° C. in 4 hours and 30 minutes in an air. After being maintained at 1350° C. for 6 hours, the molded body was cooled to room temperature in 4 hours and 30 minutes in order to obtain a sintered body. The sample was white in color.

Next, the sintered body was set in an alumina container with a lid, and aluminum metal powder was supplied into the alumina container. The alumina container was set in an electric furnace, and the inside of the furnace was exhausted to 10⁻¹ Pa, and heated to 1350° C. in 4 hours and 30 minutes. After being maintained at 1350° C. for 2 hours, the inside of the furnace was cooled to room temperature in 4 hours and 30 minutes.

It was found from an X-ray diffraction that the sintered body includes only the 12CaO—7Al₂O₃ structure, and was the mayenite compound. In addition, the electron density of the mayenite compound measured from the diffuse reflectance spectrum by the Kubelka-Munk method was 1.0×10²¹ cm⁻³. The sample was black in color. Next, cutting and polishing processes were carried out on the sintered body using no water, in order to obtain a cylindrical electrode with a covered bottom, having an outer diameter of 8.0 mmØ, an inner diameter of 5.0 mmØ, a height of 16 mm, and a depth of 5 mm.

Furthermore, the following surface treatment was carried out. That is, after setting the mayenite compound having the cylindrical shape with the covered bottom into a carbon container with a lid, the carbon container was exhausted to 10⁻⁴ Pa, and heated to 1300° C. in 24 minutes. After being maintained at 1300° C. for 6 hours, a quick cooling was made to room temperature, in order to obtain a sample F, that is, the cold cathode of the sintered body of mayenite compound. The sample F was black in color.

It was found from an X-ray diffraction that the sintered body that is obtained includes only the 12CaO—7Al₂O₃ structure. The electron density of the sample F measured from the diffuse reflectance spectrum by the Kubelka-Munk method was 6.5×10¹⁹ cm⁻³. In addition, the surface state of the sintered body observed on the SEM with a magnification of 6000 times had a three-dimensional concavo-convex structure having a domain diameter of 0.2 μm to 3 μm.

Next, in order to electrically connect lead wires to the sample F, the sample F was calked to an electrode made of nickel metal and having a cylindrical shape with a covered bottom (hereinafter also referred to as a “nickel metal cup”). The nickel metal cup had an outer diameter of 8.3 mmØ, an inner diameter of 8.1 mmØ, a height of 8.0 mm, and a depth of 7.7 mm. The “calking” refers to inserting the sample F into the nickel metal cup and fastening the sample F towards the bottom as if turning a screw, so that the sample F and a contact part of the nickel metal cup are rigidly secured. In order to facilitate insertion of the sample F into the nickel metal cup, the inner diameter of the nickel metal cup was 8.1 mmØ. The nickel metal cup may be provided with a slit in order to facilitate the calking. Kovar wires were connected in advance to the bottom of the nickel metal cup, and thus, the sample F may easily be electrically connected to the lead wires.

Molybdenum electrodes having the same shape as the sample F were provided within a glass tube having an outer diameter of 20 mmØ to oppose each other with an inter-electrode distance of approximate 10 mm. The sample F and the molybdenum metal electrode extended from the inside to the outside of the glass tube by welded kovar lead wires. The glass tube was exhausted to 10⁻⁵ Pa, maintained at 500° C. for 3 hours, and then exhausted by vacuum heating. In addition, argon gas was filled into the glass tube to 660 Pa, and the glass tube and an exhaust tube were sealed.

Next, the sample F was used as the cathode and a DC voltage was applied thereto in order to cause a glow discharge of the sample F. In addition, when the applied voltage was changed and the cathode fall voltage of the sample F was measured, the measured cathode fall voltage of the sample F was 110 V when the product Pd is approximately 5 Torr.cm. On the other hand, the cathode fall voltage for the molybdenum metal was 170 V. Accordingly, it was continued that the cathode fall voltage of the sample F is 35% lower with respect to that of the molybdenum metal.

<Resistance of Mayenite Compound To Sputtering>

In the above <Measurement of Cathode Fall Voltage (Part 6)>, an AC voltage of 800 V peak-to-peak at 50 kHz was applied, and the glow discharge was continued for 1000 hours. The inner wall of the glass tube near the molybdenum metal electrodes became black due to deposits, and it was confirmed that the molybdenum was consumed by sputtering. On the other hand, no deposits were observed on the inner wall of the glass tube near the electrodes of the sample F, and no change in external appearance was observed in that the glass tube was colorless and transparent near the electrodes of the sample F. Hence, it was confirmed that the resistance of the sample F, that is, the mayenite compound, to the sputtering is extremely superior when compared to that of the molybdenum metal.

### Practical Example 7

<Measurement of Cathode Fall Voltage (Part 7)>

The sintered body of the dense mayenite compound obtained by the above <Measurement of Cathode Fall Voltage (Part 6)> was formed to a cylindrical shape with a bottom. This mayenite compound was white in color, and the electron density thereof was 1.0×10¹⁵ cm⁻³ or less. The dimensions of the cylindrical shape were such that an outer diameter is 2.4 mmØ, an inner diameter is 2.1 mmØ, a height is 14.7 mm, and a depth is 9.6 mm. Furthermore, the following surface treatment was carried out. That is, after setting the mayenite compound having the cylindrical shape with the covered bottom into a carbon container with a lid, the carbon container with the lid was set within an electric furnace having an adjustable environment. After the air within the furnace was exhausted until the pressure became 2 Pa or less, 0.6 ppm of oxygen and nitrogen having a dew point of −90° C. were supplied to the furnace before returning the pressure inside the furnace to the atmospheric pressure. The supply of nitrogen was thereafter continued at a flow rate of 5 L/minute. The electric furnace was provided with a relief valve so that the pressure which is 12 kPa or more higher than the atmospheric pressure will not be applied inside the furnace. After heating to 1280° C. in 38 minutes and maintaining 1280° C. for 4 hours, a quick cooling was made to room temperature, in order to obtain a sample J, that is, the cold cathode of the sintered body of mayenite compound. The sample J was black in color. A plurality of such samples J were manufactured simultaneously.

Powder J1 was obtained by grinding the sample J using an automatic mortar grinder. The particle size of this powder J1 was measured by the laser diffraction scattering method (SALD-2100 manufactured by Shimadzu Corporation), and the average particle diameter was 20 μm. It was found from an X-ray diffraction that the powder J1 includes only the 12CaO—7Al₂O₃ structure. In addition, the electron density measured from the diffuse reflectance spectrum by the Kubelka-Munk method was 1.0×10¹⁹ cm⁻³.

Next, in order to electrically connect lead wires to the sample J, the sample J was calked to an electrode made nickel metal, in a manner similar to the practical example 6. The nickel metal cup had an outer diameter of 2.7 mmØ, an inner diameter of 2.5 mmØ, a height of 5.0 mm, and a depth of 4.7 mm. Kovar wires were connected in advance to the bottom of the nickel metal cup, and thus, the sample J may easily be electrically connected to the lead wires.

The sample J was set in the vacuum chamber 31 of the open cell discharge measuring apparatus 30 illustrated in FIG. 2. Molybdenum metal was used for the opposing electrode. The nickel metal electrodes were welded to the kovar lead wires in order to extend from the inside of the glass tube to the outside of the glass tube. The distance from the sample J to the opposing electrode was 2.4 mm. The vacuum chamber 31 was initially exhausted to 3×10⁻³ Pa, and argon gas was again filled to 1250 Pa. Next, in order to age the surface of the sample J, a DC voltage of 400 V was applied so that the sample J becomes the cathode and a discharge is generated for 10 minutes. After stopping the discharge and further exhausting the vacuum chamber 31 to 3×10⁻⁴ Pa, argon gas was again filled to 2000 Pa.

Next, as illustrated in FIG. 51, an AC voltage of 900 V peak-to-peak at 10 Hz was applied to measure the cathode fall voltage. The measured cathode fall voltage of the sample J was 108 V when the product Pd is approximately 6.8 Torr.cm, where P denotes the gas pressure within the vacuum chamber and d denotes the distance between the cathode and the anode. On the other hand, the cathode fall voltage for the nickel metal was 180 V. Accordingly, it was confirmed that the cathode fall voltage of the sample J is 40% lower with respect to that of the nickel metal.

### Practical Example 8

<Measurement of Cathode Fall Voltage (Part 8)>

A sintered body of a mayenite compound having an electron density of 1.0×10¹⁹ cm⁻³ was manufactured, instead of a metal cold cathode including the mayenite compound. First, an EVA resin (ethylene-vinyl acetate copolymer) and an acrylic resin were added as binders, a denatured wax was added as a lubricant, and dibutyl phthalate was added as a plasticizer to the mayenite compound powder A2 and kneaded. The compounding ratio in weight of [powder A2]:[EVA resin]:[acrylic resin]:[denatured wax]:[dibutyl phthalate] was 8.0:0.8:1.2:1.6:0.4. A molded body having a cylindrical shape with a covered bottom was manufactured by injection molding of the powder A2 in the mixed state.

Next, the molded body was maintained in air at 520° C. for 3 hours in order to remove the binder component. Further, the molded body was maintained in air at 1300° C. for 2 hours in order to obtain a sintered body of the mayenite compound. The sintered body of the mayenite compound was set in a carbon container with a lid, and the carbon container with the lid was subjected to a heat treatment within nitrogen at 1280° C. for 30 minutes. As a result, a sample K, which is a mayenite compound having an electron density of 1.0×10¹⁹ cm⁻⁻³ was obtained. The cup-shaped sintered body in this state had an outer diameter of 1.9 mmØ, a height of 9.2 mm, a depth of 8.95 mm, and a thickness of 0.25 mm.

The sample K was calked to a nickel metal cup in a manner similar to the above <Measurement of Cathode Fall Voltage (Part 7)>. The nickel metal cup had an outer diameter of 2.7 mmØ, an inner diameter of 2.5 mmØ, a height of 10.0 mm, and a depth of 9.7 mm. The sample K was set in the vacuum chamber 31 of the open cell discharge measuring apparatus 30 illustrated in FIG. 2. The nickel metal cup of the above dimensions was provided as the opposing electrode. The nickel metal electrode was welded to the kovar lead wire in order to extend from the inside of the glass tube to the outside of the glass tube. The distance from the sample K to the opposing electrode was 3.0 mm. The vacuum chamber 31 was initially exhausted to 9×10⁻⁴ Pa, and argon gas was again filled to 3000 Pa. Then, in order to age the surface of the sample K, a DC voltage was applied to cause a discharge for 15 minutes. A DC voltage of 600 V was applied to discharge the sample K, so that the sample K becomes the cathode. Further, the vacuum chamber 31 was exhausted to 3×10⁻⁴ Pa after the plasma treatment, and argon gas was again filled to 2000 Pa.

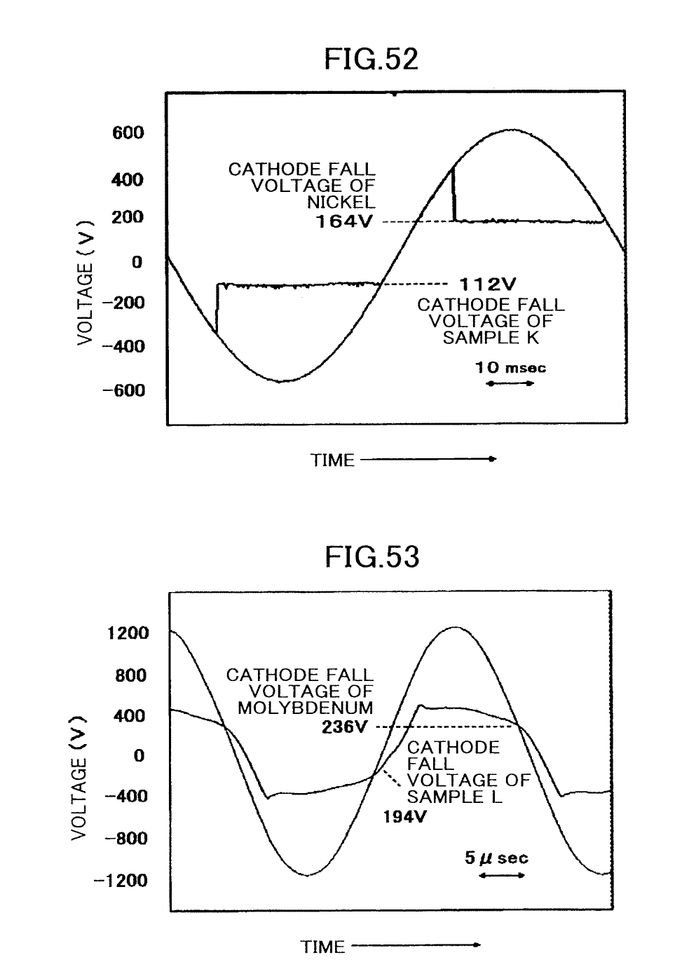

As illustrated in FIG. 52, an AC voltage of 1200 V peak-to-peak at 10 Hz was applied, and the measured cathode fall voltage of the sample K was 112 V when the product Pd is approximately 12.5 Torr.cm, where P denotes the gas pressure within the vacuum chamber and d denotes the distance between the cathode and the anode. On the other hand, the cathode fall voltage for the nickel metal was 164 V. Accordingly, it was confirmed that the cathode fall voltage of the sample K is 32% lower with respect to that of nickel metal.

### Practical Example 9

<Measurement of Cathode Fall Voltage (Part 9)>

In the above <Coating of Mayenite Compound>, a rod electrode having a cylindrical column shape was manufactured. The rod electrode was made of molybdenum metal, and had a diameter of 2.7 mmØ and a length of 15 mm. The paste A was coated on an end part and a side surface of the electrode, to a length of 7 mm from the end part of the electrode. The paste E was also coated on a top surface of the cylindrical column shape foisting a tip end of the electrode. Next, in the above <Firing of Mayenite Compound>, the furnace was exhausted to 10⁻⁴ Pa, and 0.6 ppm of oxygen and nitrogen having a dew point of −90° C. were supplied to the furnace before returning the pressure inside the furnace to the atmospheric pressure. The supply of nitrogen was thereafter continued at a flow rate of 3 L/minute. The electric furnace was provided with a relief valve so that a pressure which is 12 kPa or more higher than the atmospheric pressure will not be applied inside the furnace. After heating to 1300° C. in 41 minutes and maintaining 1300° C. for 30 minutes, a quick cooling was made to room temperature, in order to obtain a sample L.

It was found from an X-ray diffraction that the coated part of the sample L includes only the 12CaO—7Al₂O₃ structure, and is a mayenite compound. In addition, the electron density of the mayenite compound at the coated part measured from the diffuse reflectance spectrum by the Kubelka-Munk method was 3.7×10¹⁹ cm⁻³.

Thereafter, the sample L was set in the vacuum chamber 31 of the open cell discharge measuring apparatus 30 illustrated in FIG. 2. The molybdenum metal having the same rod shape as the sample L was provided as the opposing electrode. The vacuum chamber was initially exhausted to 3×10⁻⁴ Pa, and argon gas was again filled to 5500 Pa.

Next, as illustrated in FIG. 53, an AC voltage of 1240 V peak-to-peak at 30 kHz was applied to cause a glow discharge. The measured cathode fall voltage of the sample L was 194 V when the product Pd is approximately 12.4 Torr.cm. On the other hand, the cathode fall voltage for the molybdenum metal was 236 V. Accordingly, it was confirmed that the cathode fall voltage of the sample L is 18% lower with respect to that of the molybdenum metal.

### Practical Example 10

<Measurement of Cathode Fall Voltage & Discharge Firing Voltage>

In the above <Coating of Mayenite Compound>, a flat plate-shaped electrode was manufactured in place of the substrate in order to obtain a sample M in a similar manner. The electrode was made of molybdenum metal, and had a width of 1.5 mm, a length of 15 mm, and a thickness of 0.1 mm. The paste A was coated on both sides of the strip-shaped electrode, to a length of 12 mm from an end part of the electrode. It was found from an X-ray diffraction that the coated part of the sample M includes only the 12CaO—7Al₂O₃ structure, and is a mayenite compound. In addition, the electron density of the mayenite compound at the coated part measured from the diffuse reflectance spectrum by the Kubelka-Munk method was 1.7×10¹⁹ cm ⁻³.

Thereafter, the sample M was set in the vacuum chamber 31 of the open cell discharge measuring apparatus 30 illustrated in FIG. 2. The molybdenum metal having the same strip shape as the sample M was provided as the opposing electrode. The distance from the sample M to the opposing electrode was 2.8 mm. The vacuum chamber 31 was initially exhausted to 3×10⁻⁴ Pa, and argon gas was again filled.

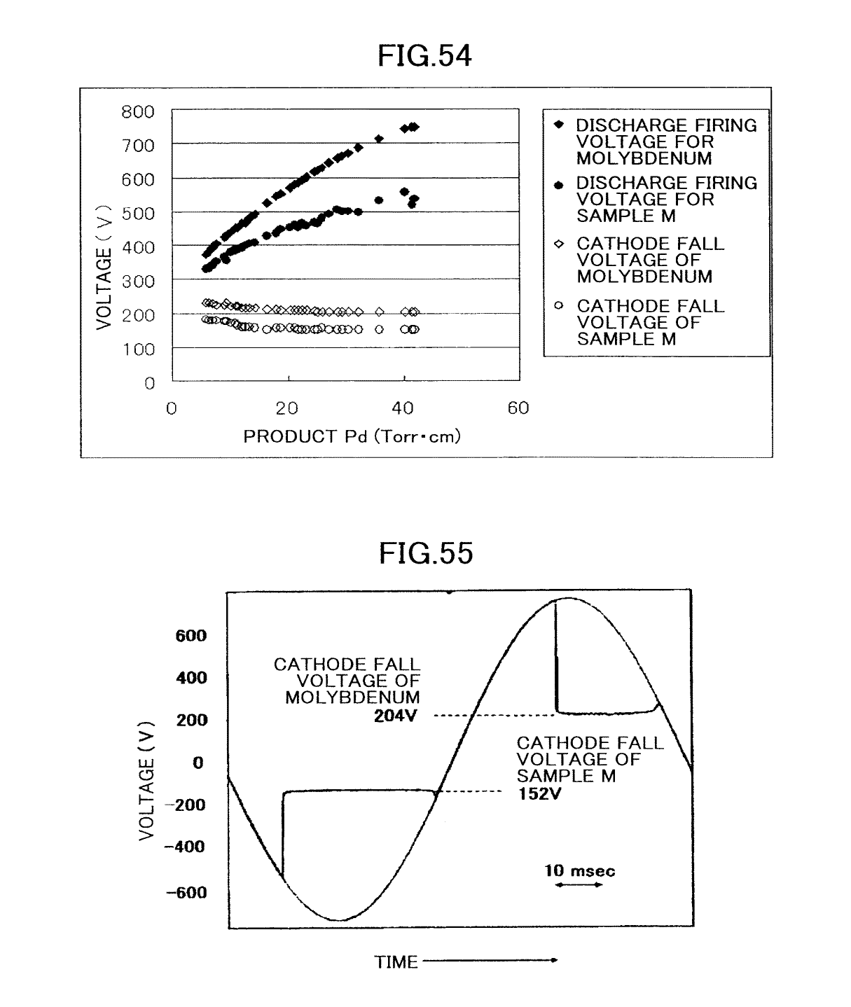

Next, the cathode fall voltage and a discharge firing voltage were measured for the sample M and the molybdenum metal electrode while varying the product Pd. The inter-electrode distance was maintained constant, and only the gas pressure was varied. An AC voltage at 10 Hz was applied. As illustrated in FIG. 54, it was found that the cathode fall voltage and the discharge firing voltage for the sample M were lower than those of the molybdenum metal for all ranges of the product Pd. For example, the cathode fall voltage of the sample M was 152 V and the discharge firing voltage of the sample M was 556 V when the product Pd is 40.3 Torr.cm, as illustrated in FIG. 55. On the other hand, the cathode fall voltage and the discharge firing voltage for the molybdenum metal was 204 V and 744 V, respectively. Accordingly, it was confirmed that the cathode fall voltage of the sample M is 25% lower with respect to that of the molybdenum metal, and that the discharge firing voltage of the sample M is 25% lower with respect to that of the molybdenum metal.

### Practical Example 11

<Tube Voltage Measurement in Cold Cathode Fluorescent Lamp>

The paste A was coated on the inner surface of the cup-shaped nickel electrode without a gap, and maintained at 120° C. for 1 hour and dried. The dimensions of the cup-shaped nickel electrode were such that an outer diameter is 2.7 mmØ, an inner diameter is 2.5 mmØ, a height is 5.0 mm, and a depth is 4.7 mm. Next, the cup-shaped nickel electrode coated with the paste A was set on a Al₂O₃ plate arranged at the bottom within a carbon container with a lid, and the carbon container with the lid was thereafter set within an electric furnace having an adjustable environment. After the air within the furnace was exhausted until the pressure became 2 Pa or less, 0.6 ppm of oxygen and nitrogen having a dew point of −90° C. were supplied to the furnace before returning the pressure inside the furnace to the atmospheric pressure. The supply of nitrogen was thereafter continued at a flow rate of 5 L/minute. The electric furnace was provided with a relief valve so that the pressure which is 12 kPa or more higher than the atmospheric pressure will not be applied inside the furnace. After heating to 1300° C. in 39 minutes and maintaining 1300° C. for 30 minutes, a quick cooling was made to room temperature, in order to obtain a sample N, that is, the cup-shaped nickel electrode having the inner surface coated with the mayenite compound.

Next, a description will be given of a procedure used to manufacture a CCFL (Cold Cathode Fluorescent Lamp) using the sample N as the electrode. The sample N was arranged on both ends of a glass tube having an outer diameter of 4 mm and an inner diameter of 3 mm, with a center part branching in a T-shape in order to enable evacuation, so that the electrode separation is fixed to 250 mm by melting glass beads by a burner. Next, the inside of the lamp was evacuated to 1.3×10⁻⁻³ Pa, and an activation was carried out at 400° C. The activation refers to a process of removing contamination within the lamp.

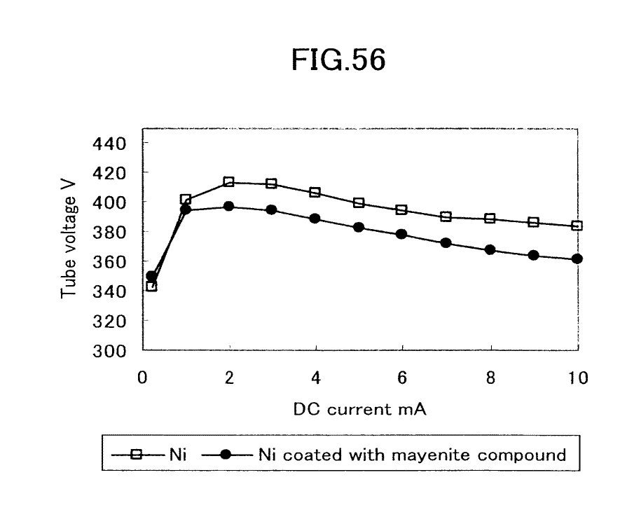

Thereafter, 120 mg of mercury was supplied, and an evacuation was again carried out to 1.3×10⁻³ Pa. Finally, argon gas was filled to 2660 Pa, and the lamp was disconnected from the exhaust system. At the same time, a CCFL using a cup-shaped nickel electrode not coated with the mayenite compound was manufactured in a similar manner. The manufactured CCFLs were turned on using an AC circuit, and aged at an effective current of 7 mALms. After aging for 250 hours or more, a tube voltage was measured by varying the current from 0.2 mA to 10 mA by a DC circuit. FIG. 56 illustrates a tube current versus tube voltage characteristic that is obtained from the measurement. A ballast resistor was set to 100 kΩ. The ballast resistor prevents excess current from flowing when the discharge starts, and functions to stabilize the entire circuit. It was confirmed that the voltage decreases by approximately 5% between 2 mA and 10 mA when the mayenite compound is coated on the inner surface of the cup-shaped nickel electrode.

### Comparison Example 1

<Measurement of Cathode Fall Voltage (Part 10)>

In the above <Firing of Mayenite Compound>, the pressure at the time of the exhausting was set to 10⁻² Pa, and the heat treatment temperature was set to 500° C., but the sintering was otherwise made in a similar manner in order to obtain a sample G. It was found from an X-ray diffraction that the coated part of the electrode includes only the 12CaO—7Al₂O₃ structure, and is a mayenite compound. In addition, the electron density of the mayenite compound coated on the electrode, calculated based on a measurement using the ESR apparatus, was 6.5×10¹⁶ cm⁻³. In addition, the surface state of the mayenite compound observed on the SEM with a magnification of 6000 times had a three-dimensional concavo-convex structure having a domain diameter of 0.1 μm to 8 μm. The discharge did not stabilize when an AC voltage of 600 V peak-to-peak at 10 Hz was applied, but the cathode fall voltage could not be measured.

### Comparison Example 2

<Measurement of Cathode Fall Voltage (Part 11)>

In the above <Firing of Mayenite Compound>, the pressure at the time of the exhausting was set to 10⁻² Pa, and an alumina container was used in place of the carbon container with the lid, but the sintering was otherwise made in a similar manner in order to obtain a sample H. It was found from an X-ray diffraction that the coated part of the electrode includes only the 12CaO—7Al₂O₃ structure, and is a mayenite compound. In addition, the electron density of the mayenite compound coated on the electrode, calculated based on a measurement using the ESR apparatus, was 1.0×10¹⁵ cm⁻³. In addition, the surface state of the mayenite compound observed on the SEM with a magnification of 6000 times had a three-dimensional concavo-convex structure having a domain diameter of 0.2 μm to 5 μm. The discharge did not stabilize when an AC voltage of 600 V peak-to-peak at 10 Hz was applied, but the cathode fall voltage could not be measured.

### Comparison Example 3

<Measurement of Cathode Fall Voltage (Part 12)>

In the above <Measurement of Cathode Fall Voltage (Part 6)>, the above <Firing of Mayenite Compound> was not carried out in order to obtain a sample I. The sample I was black in color. It was found from an X-ray diffraction that the coated part of the electrode includes only the 12CaO—7Al₂O₃ structure, and is a mayenite compound. In addition, the electron density of the mayenite compound coated on the electrode measured from the diffuse reflectance spectrum by the Kubelka-Munk method was 1.0×10²¹ cm ⁻³. In addition, the surface state of the mayenite compound observed on the SEM with a magnification of 6000 times did not have a three-dimensional concavo-convex structure. The cathode fall voltage of the sample I measured in a manner similar to the above <Measurement of Cathode Fall Voltage (Part 6)> was 148 V. On the other hand, the cathode fall voltage with respect to the molybdenum metal was 170 V. Accordingly, it was confirmed that the cathode fall voltage of the sample I is only 13% lower with respect to that of the molybdenum metal.

As described above, according to the embodiments and practical examples, at least a part of a cold cathode for a discharge lamp includes a mayenite compound, and a surface of a surface layer of the mayenite compound is fired in a vacuum atmosphere with an oxygen partial pressure of 10⁻³ Pa or less, an inert gas atmosphere with an oxygen partial pressure of 10⁻³ Pa or less, or a reducing atmosphere with an oxygen partial pressure of 10⁻³ Pa or less, in order to reduce a cathode fall voltage and reduce power consumption. More particularly, by this surface treatment, the cathode fall voltage may be made lower than that for nickel, molybdenum, tungsten, niobium, and alloy of iridium and rhodium.

Further, a longer life may be achieved by improving resistance to sputtering.

The present invention is described above in detail with reference to specific embodiments and practical examples, however, it may be apparent to those skilled in the art that various variations and modifications may be made without departing from the spirit and scope of the present invention.

What is claimed is:

1. An electrode for a discharge lamp, comprising a mayenite compound in at least a part of the electrode emitting secondary electrons, wherein the mayenite compound is fired in a vacuum atmosphere with an oxygen partial pressure of 10⁻³ Pa or less, an inert gas atmosphere with an oxygen partial pressure of 10⁻³ Pa or less, or a reducing atmosphere with an oxygen partial pressure of 10⁻³ Pa or less.

2. The electrode for the discharge lamp as claimed in claim 1, wherein the electrode includes a metal base, and the mayenite compound is provided in at least a part of the metal base.

3. The electrode for the discharge lamp as claimed in claim 1, wherein at least a part of the electrode is formed by a sintered body of the mayenite compound, at least a part of free oxygen ions of the mayenite compound is substituted by electrons, and an electron density is 1×10¹⁹ cm⁻³ or higher.

4. The electrode for the discharge lamp as claimed in claim 1, wherein sintering is performed in a reducing atmosphere.

5. The electrode for the discharge lamp as claimed in claim 1, wherein firing is performed within a carbon container.

6. The electrode for the discharge lamp as claimed in claim 1, wherein the mayenite compound includes a 12CaO—7Al₂O₃ compound, a 12SrO—7Al₂O₃ compound, a mixed crystal compound of those, or an isomorphic compound of those.

7. A discharge lamp comprising:
the electrode for the discharge lamp as claimed in claim 1.

8. A method of manufacturing an electrode for a discharge lamp, comprising:
foaming a part of the electrode or the electrode in its entirety by a mayenite compound, and thereafter firing the mayenite compound in a vacuum atmosphere with an oxygen partial pressure of 10⁻³ Pa or less, an inert gas atmosphere with an oxygen partial pressure of 10⁻³ Pa or less, or a reducing atmosphere with an oxygen partial pressure of 10⁻³ Pa or less.

9. A discharge lamp comprising:
the electrode for the discharge lamp manufactured by the method as claimed in claim 8.

10. A discharge lamp comprising:
a glass tube;
a discharge gas sealed inside the glass tube; and
a mayenite compound provided inside the glass tube at a part making contact with the discharge gas,
wherein the mayenite compound is fired in a vacuum atmosphere with an oxygen partial pressure of 10⁻³ Pa or less, an inert gas atmosphere with an oxygen partial pressure of 10⁻³ Pa or less, or a reducing atmosphere with an oxygen partial pressure of 10⁻³ Pa or less.
